(19) United States
(12) Patent Application Publication
(10) Pub. No.: US 2025/0013400 A1
(43) Pub. Date: Jan. 9, 2025

(54) EMISSION CALCULATION SYSTEM, INFORMATION PROCESSING SYSTEM, EMISSION CALCULATION METHOD, AND RECORDING MEDIUM

(71) Applicants: Hiroyuki MATSUSHIMA, Kanagawa (JP); Natsuho IKEZAWA, Tokyo (JP); Takumi NAKAMURA, Kanagawa (JP); Saeko SETOGUCHI, Kanagawa (JP)

(72) Inventors: Hiroyuki MATSUSHIMA, Kanagawa (JP); Natsuho IKEZAWA, Tokyo (JP); Takumi NAKAMURA, Kanagawa (JP); Saeko SETOGUCHI, Kanagawa (JP)

(21) Appl. No.: 18/757,623

(22) Filed: Jun. 28, 2024

(30) Foreign Application Priority Data
Jul. 4, 2023 (JP) 2023-109936

(51) Int. Cl. G06F 3/12

(52) U.S. Cl. CPC G06F 3/1219; G06F 3/1221; G06F 3/1229

(57) ABSTRACT

A system for calculating emission, includes circuitry that acquires, from a first terminal, order information including processing conditions of one or more processes for producing a product; registers in a memory first job information based on the order information; transmits the first job information to one or more management apparatuses that manage execution of the one or more processes; acquires result information indicating a result of executing the one or more processes; calculates, based on the result information, an actual value of carbon dioxide emissions for a first job corresponding to the first job information; and in a case that second job information is registered, calculates a predicted value of carbon dioxide emissions for a second job corresponding to the second job information, based on the actual value of carbon dioxide emissions for the first job.

### CROSS-REFERENCE TO RELATED APPLICATIONS

This patent application is based on and claims priority pursuit to 35 U.S.C. § 119 (a) to Japanese Patent Application No. 2023-109936, filed on Jul. 4, 2023, in the Japan Patent Office, the entire disclosure of which is hereby incorporated by reference herein.

### BACKGROUND

### Technical Field

The present disclosure relates to an emission calculation system, an information processing system, an emission calculation method, and a recording medium.

### Related Art

The carbon offsetting is a mechanism that enables entities to compensate for all or a part of their greenhouse gas emissions by investing in other activities (for example, forestation) that reduce, avoid or remove emissions. The offsetting involves buying and selling of carbon credits, which represent a reduction, avoidance or removal of a certain amount of carbon dioxide.

For example, the background system calculates the greenhouse gas emissions such as CO2 emissions generated in the process of producing a product, and performs carbon offsetting to offset the calculated greenhouse gas emissions.

### SUMMARY

Example embodiments include a system for calculating emission, includes circuitry that acquires, from a first terminal, order information including processing conditions of one or more processes for producing a product; registers in a memory first job information based on the order information; transmits the first job information to one or more management apparatuses that manage execution of the one or more processes; acquires result information indicating a result of executing the one or more processes; calculates, based on the result information, an actual value of carbon dioxide emissions for a first job corresponding to the first job information; and in a case that second job information is registered, calculates a predicted value of carbon dioxide emissions for a second job corresponding to the second job information, based on the actual value of carbon dioxide emissions for the first job.

Example embodiments include an information processing system including the above-described system, and the first terminal including a display that displays the predicted value of carbon dioxide emissions corresponding to the order information.

Example embodiments include a method of calculating emission, including: acquiring, from a first terminal, order information including processing conditions of one or more processes for producing a product; registering in a memory first job information based on the order information; transmitting the first job information to one or more management apparatuses that manage execution of the one or more processes; acquiring result information indicating a result of executing the one or more processes; calculating, based on the result information, an actual value of carbon dioxide emissions for a first job corresponding to the first job information; and calculating a predicted value of carbon dioxide emissions for a second job corresponding to second job information that is registered after the registration of the first job information, based on the actual value of carbon dioxide emissions for the first job.

Example embodiments include a non-transitory recording medium storing a plurality of instructions which, when executed by one or more processors, causes the processors to perform a method including: acquiring, from a first terminal, order information including processing conditions of one or more processes for producing a product; registering in a memory first job information based on the order information; transmitting the first job information to one or more management apparatuses that manage execution of the one or more processes; acquiring result information indicating a result of executing the one or more processes; calculating, based on the result information, an actual value of carbon dioxide emissions for a first job corresponding to the first job information; and calculating a predicted value of carbon dioxide emissions for a second job corresponding to second job information that is registered after the registration of the first job information, based on the actual value of carbon dioxide emissions for the first job.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example configuration of an information processing system;

FIG. 2 is a diagram illustrating example operation performed by the information processing system of FIG. 1;

FIG. 3 is a diagram illustrating an example hardware configuration of an emission calculation system;

FIG. 4 is a diagram illustrating an example hardware configuration of a seller terminal;

FIG. 5 is a diagram illustrating a hardware configuration of a printer;

FIG. 6 is a diagram illustrating an example functional configuration of the information processing system of FIG. 1;

FIG. 7 is an example table storing the printing conditions, the amount of emissions, the estimated cost, and the estimated credit;

FIG. 8 is a diagram illustrating an example structure of data processed by the information processing system of FIG. 1;

FIG. 9 is a sequence diagram illustrating example operation of processing an order, performed by the information processing system of FIG. 1;

FIG. 10 is a diagram illustrating an example of screen transitions when order processing is performed by the information processing system of FIG. 1;

FIG. 11 is an illustration of an example home screen, displayed when processing an order;

FIG. 12 is an illustration of an example order entry screen, displayed when processing an order.

FIG. 13 is an illustration of another example order entry screen, displayed when processing an order;

FIG. 14 is an illustration of another example order entry screen, displayed when processing an order;

FIG. 15 is an illustration of an example order registration screen, displayed when processing an order;

FIG. 16 is a diagram illustrating an example of email transmitted when order processing is performed;

FIG. 17 is an illustration of an example report when order processing is performed;

FIG. 18 is a sequence diagram illustrating example operation of registering a job, performed by the information processing system of FIG. 1;

FIG. 19 is a diagram illustrating an example of screen transitions when job registration is performed by the information processing system of FIG. 1;

FIG. 20 is an illustration of an example order list screen when job registration is performed;

FIG. 21 is an illustration of an example order details screen when job registration is performed;

FIG. 22 is an illustration of an example job entry screen when job registration is performed;

FIG. 23 is an illustration of another example job entry screen when job registration is performed;

FIG. 24 is an illustration of an example job registration screen when job registration is performed;

FIG. 25 is a sequence diagram illustrating example operation of executing a process and entering a result of the process, performed by the information processing system of FIG. 1;

FIG. 26 is a diagram illustrating an example of screen transitions when processing to execute the process and enter the result is performed by the information processing system of FIG. 1;

FIG. 27 is an illustration of an example job list screen when processing to execute the process and enter the result is performed by the information processing system of FIG. 1;

FIG. 28 is an illustration of an example job details screen when processing to execute process and enter result is performed;

FIG. 29 is an illustration of an example result entry screen when processing to execute the process and the enter result is performed;

FIG. 30 is an illustration of another example result entry screen when processing to execute the process and enter the result is performed;

FIG. 31 is a sequence diagram illustrating another example operation of executing a process and entering a result of the process, performed by the information processing system 1;

FIG. 32 is a sequence diagram illustrating example operation of processing completion of a job, performed by the information processing system of FIG. 1;

FIG. 33 is a diagram illustrating an example of screen transitions when job completion processing is performed by the information processing system of FIG. 1;

FIG. 34 is an illustration of an example job list screen when job completion processing is performed;

FIG. 35 is an illustration of an example job details screen when job completion processing is performed;

FIG. 36 is a sequence diagram illustrating example operation of checking the process result, performed by the information processing system of FIG. 1;

FIG. 37 is a diagram illustrating an example of screen transitions when processing of checking the result is performed by the information processing system of FIG. 1;

FIG. 38 is an illustration of an example result list screen when checking is performed;

FIG. 39 is an illustration of an example result details screen when checking is performed;

FIG. 40 is a diagram illustrating example processing conditions of the processes for producing the printed matter; and

FIG. 41 is a diagram illustrating example processing conditions of the processes for producing the clothing.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An example emission calculation system, an example emission calculation method, and an example program are described below with reference to the drawings.

### Configuration and Operation of Information Processing System

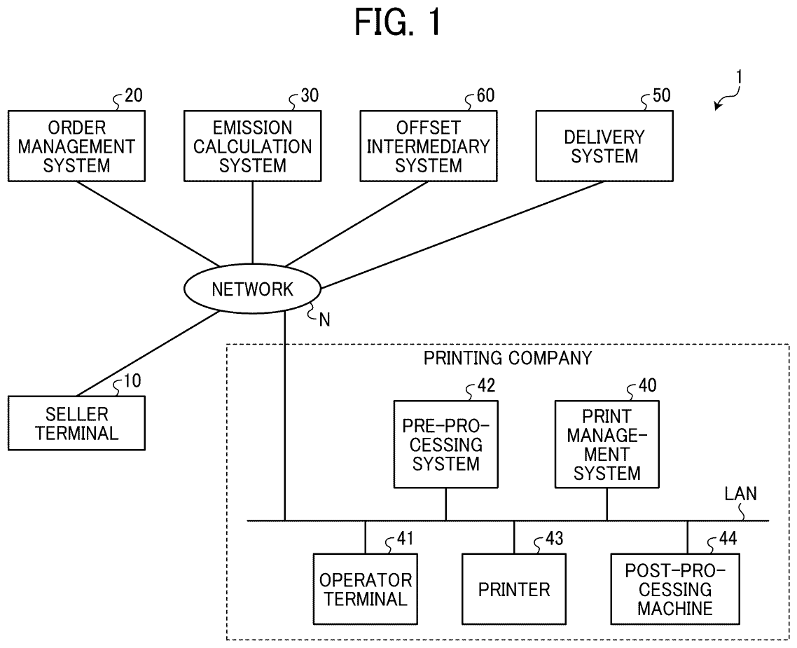

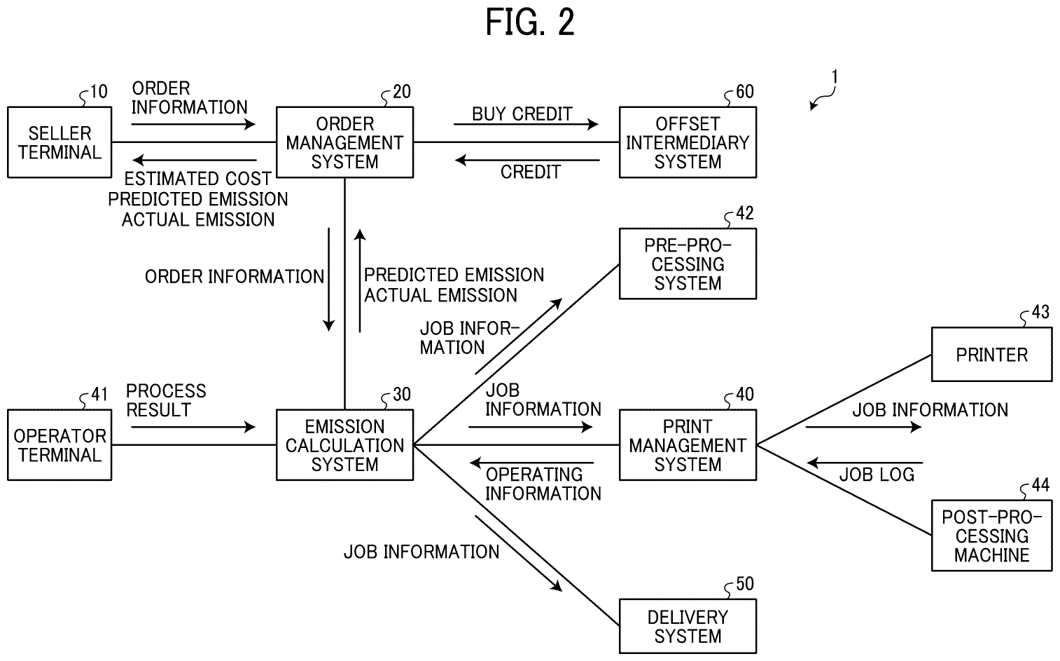

FIG. 1 is a diagram illustrating an example configuration of an information processing system 1. FIG. 2 is a diagram illustrating example operation performed by the information processing system 1 of FIG. 1. The configuration and the operation of the information processing system 1 are described with reference to FIGS. 1 and 2.

The information processing system 1 illustrated in FIG. 1 calculates an actual value and a predicted value of carbon dioxide emissions generated in the processes to produce products. As illustrated in FIG. 1, the information processing system 1 includes a seller terminal 10 (an example of a first terminal), an order management system 20, an emission calculation system 30, a print management system 40 (an example of a management apparatus), an operator terminal 41, a pre-processing system 42 (another example of the management apparatus), a printer 43, a post-processing machine 44 (another example of the management apparatus), a delivery system 50 (another example of the management apparatus), and an offset intermediary system 60. The functions of any one of the above-described example management apparatuses may be alternatively performed by the emission calculation system 30. In one example, the print management system 40, the operator terminal 41, the pre-processing system 42, the printer 43, and the post-processing machine 44 reside on a site managed by a printing company.

The seller terminal 10, the order management system 20, the emission calculation system 30, the print management system 40, the delivery system 50, and the offset intermediary system 60 are communicable with one another via a network N. The print management system 40, the operator terminal 41, the pre-processing system 42, the printer 43, and the post-processing machine 44, each managed by the printing company, are connected to a local area network (LAN) to communicate data therebetween.

As described below, in a case where the operator terminal 41 is an information terminal operated by a process supervisor, the operator terminal 41 may not be provided at the side managed by the printing company. In other words, the operator terminal 41, which is one example of a second terminal, may be operated by the process supervisor who manages the entire production processes, or the process operator who is in charge of a specific process, for example, by operating the machine. However, one operator terminal 41 may be shared between the process supervisor and the process operator. Further, the same person may have a role as the process supervisor and a role as the process operator.

The seller terminal 10 is an information terminal such as a smartphone, a tablet terminal, or a personal computer (PC), which is operated by a sales representative, and inputs order information in response to a request from a customer.

The order management system 20 is implemented by a server apparatus or a server system, which manages the order information input by the seller terminal 10. For example, the order management system 20 registers the order information.

The emission calculation system 30 is implemented by a server apparatus or a server system. The emission calculation system 30 manages job information based on the order information registered by the order management system 20. The emission calculation system 30 further calculates an actual value of carbon dioxide emissions (“actual emission”) during the processes to produce the products based on the job information. The emission calculation system 30 further calculates a predicted value of carbon dioxide emissions (“predicted emission”), which is calculated so as to reflect the actual value.

The print management system 40 is implemented by a server apparatus or a server system that manages execution of a printing process. Specifically, the print management system 40 transmits job information to such as the printer 43 and the post-processing machine 44 to instruct execution of printing and post-processing. The print management system 40 further collects a log of jobs (job log) that have been performed, such as information indicating the result obtained by executing the processes of the job, as operating information (an example of result information), and transmits the job log to the emission calculation system 30.

The operator terminal 41, which is an information terminal such as a PC, is operated by the operator in charge of each process to instruct execution of each process and enter records based on a result of the executed process. In the following, the operator terminal 41 is also used as an information terminal operated by the process supervisor.

The pre-processing system 42, which is an information processing apparatus or an information processing system, performs pre-processing such as designing, imposition, and color profile creation of a printed matter. The printer 43, which is an example image forming apparatus, prints output based on the job information received from the print management system 40.

The post-processing machine 44 is implemented by one or more machines, which perform post-processing such as cutting, folding, bookbinding, or gloss finishing of the printed matter printed out by the printer 43.

The delivery system 50, which is implemented by a server apparatus or a server system, manages a process of delivering the printed matter produced by the printer 43 and the post-processing machine 44 at the printing company.

The offset intermediary system 60, which is implemented by a server apparatus or a server system, intermediates trading of credits between entities, which is a process of carbon offsetting, in response to a request from the order management system 20.

The pre-processing system 42, the post-processing machine 44, and the delivery system 50 are examples of entity that processes a specific process as described above. Any one of the pre-processing system 42, the post-processing machine 44, and the delivery system 50 may not be included in the information processing system 1. The information processing system 1 may further include other apparatuses that perform any one of the above-described or other processes.

### Hardware Configuration of Emission Calculation System

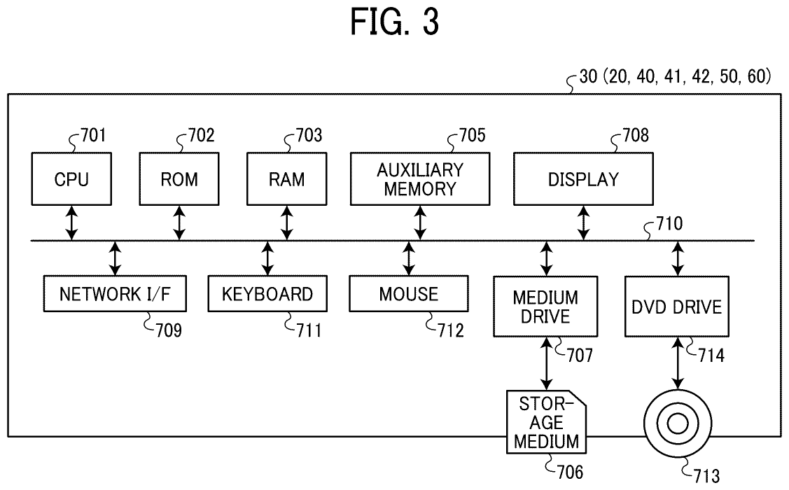

FIG. 3 is a diagram illustrating an example hardware configuration of the emission calculation system 30. Referring to FIG. 3, the hardware configuration of the emission calculation system 30 is described.

As illustrated in FIG. 3, the emission calculation system 30 includes a central processing unit (CPU) 701, a read only memory (ROM) 702, a random access memory (RAM) 703, an auxiliary memory 705, a medium drive 707, a display 708, a network interface (I/F) 709, a keyboard 711, a mouse 712, and a digital Versatile Disc (DVD) drive 714.

The CPU 701 is a processor that controls entire operation of the emission calculation system 30. The ROM 702 is a nonvolatile memory that stores a program for the emission calculation system 30. The RAM 703 is a volatile memory used as a work area for the CPU 701.

The auxiliary memory 705 is a memory such as a hard disk drive (HDD) or a solid state drive (SSD) that stores various data or programs. The medium drive 707 controls reading and writing of data from and to a storage medium 706 such as a flash memory under control of the CPU 701.

The display 708 is implemented by a liquid crystal display (LCD), an organic electro-luminescence (EL) display, etc., which displays various types of information such as a cursor, a menu, a window, characters, or an image.

The network I/F 709 is an interface circuit that communicates with an external device such as the order management system 20 via the network N. The network I/F 709 is, for example, a network interface card (NIC) in compliance with ETHERNET and can establish wired or wireless communications in compliance with Transmission Control Protocol (TCP)/Internet protocol (IP).

The keyboard 711 is an example of input device used for selecting characters, numbers, or various commands, and for moving a cursor. The mouse 712 is another example of input device used for selecting commands from options or executing commands, selecting a subject to be processed, or moving the cursor.

The DVD drive 714 is a device that reads or writes data with respect to a DVD 713 such as a DVD-ROM or a digital versatile disk recordable (DVD-R), which is an example of a removable storage medium.

The CPU 701, the ROM 702, the RAM 703, the auxiliary memory 705, the medium drive 707, the display 708, the network I/F 709, the keyboard 711, the mouse 712, and the DVD drive 714 are communicably connected to each other through a bus line 710 such as an address bus or a data bus.

The hardware configuration of the emission calculation system 30 illustrated in FIG. 3 is just one example, and the emission calculation system 30 may not include all of the components illustrated in FIG. 3, or may include any other hardware components. The emission calculation system 30 is not limited to the single information processing apparatus illustrated in FIG. 3, and may be configured by a plurality of information processing apparatuses that are communicable via a network. The order management system 20, the print management system 40, the operator terminal 41, the pre-processing system 42, the delivery system 50, and the offset intermediary system 60 may have a hardware structure substantially similar to the structure illustrated in FIG. 3. Alternatively, any one of the order management system 20, the emission calculation system 30, the print management system 40, the operator terminal 41, the pre-processing system 42, the delivery system 50, and the offset intermediary system 60 may not have the hardware structure identical to the structure illustrated in FIG. 3. For example, for any one of the systems implemented by the server, the input device such as the keyboard 711 and the mouse 712 does not have to be provided.

### Hardware Configuration of Seller Terminal

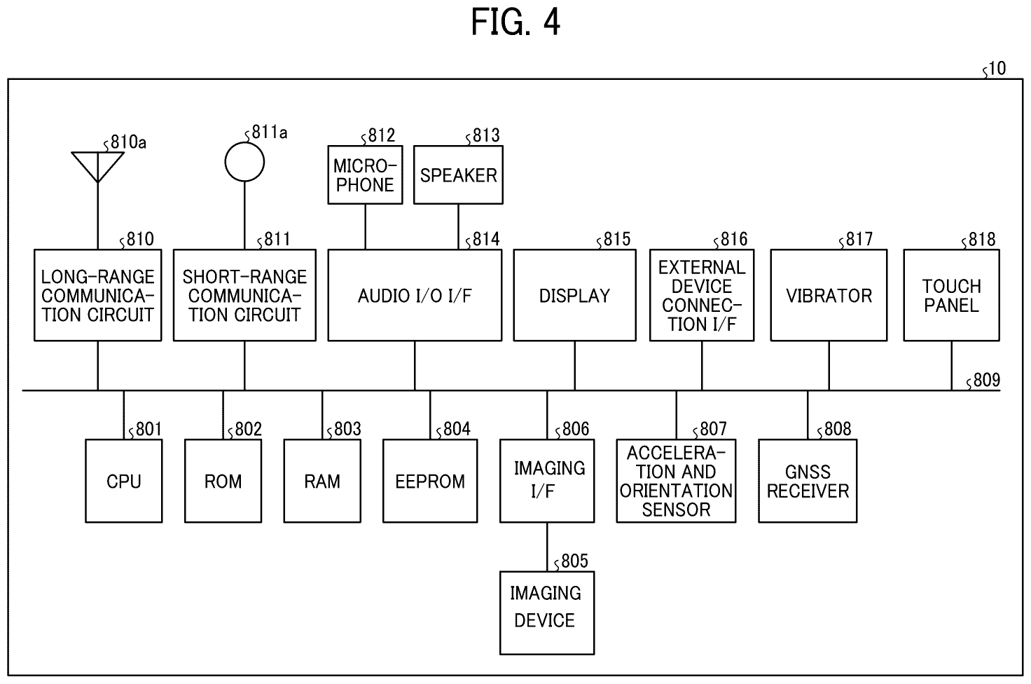

FIG. 4 is a diagram illustrating an example hardware configuration of the seller terminal 10. The hardware configuration of the seller terminal 10 is described with reference to FIG. 4.

As illustrated in FIG. 4, the seller terminal 10 includes a CPU 801, a ROM 802, a RAM 803, an electrically erasable programmable read only memory (EEPROM) 804, an imaging device 805, an imaging I/F 806, an acceleration-and-orientation sensor 807, and a global navigation satellite system (GNSS) receiver 808.

The CPU 801 is a processor that controls entire operation of the seller terminal 10. The ROM 802 is a nonvolatile memory that stores a program for executing the CPU 801, such as an initial program loader (IPL). The RAM 803 is a volatile memory used as a work area for the CPU 801. The EEPROM 804 is a non-volatile memory that stores various types of data such as programs.

The imaging device 805 is a built-in imaging device, such as a camera, which captures an image of a subject by an image sensor such as a complementary metal oxide semiconductor (CMOS) to obtain image data under the control of the CPU 801. The image sensor may be an image sensor other than the CMOS, such as a charge coupled device (CCD). The imaging I/F 806 is an interface circuit used for controlling the driving of the imaging device 805.

The acceleration-and-orientation sensor 807 includes various sensors such as an electromagnetic compass for detecting geomagnetism, a gyrocompass, and an acceleration sensor.

The GNSS receiver 808 is a circuit that receives a positioning signal from a positioning satellite. Specifically, in this example, the GNSS 808 receives a Global Positioning System (GPS) signal from a GPS satellite.

As illustrated in FIG. 4, the seller terminal 10 further include a long-range communication circuit 810, an antenna 810a, an antenna 811a, a short-range communication circuit 811, an antenna 811a, a microphone 812, a speaker 813, an audio input/output I/F 814, a display 815, an external device connection I/F 816, a vibrator 817, and a touch panel 818.

The long-range communication circuit 810 is a communication circuit that communicates wirelessly with another device via the antenna 810a through the network N, for example, in compliance with WIFI.

The short-range communication circuit 811 is a communication circuit that performs short-range wireless communication with another device via the antenna 811a, for example, in compliance with near field communication (NFC) or BLUETOOTH.

The microphone 812 is a built-in circuit that converts collected sound into an electrical signal. The speaker 813 is a built-in circuit that converts the electric signal into physical vibration to output sound such as music or voice.

The audio I/O I/F 814 is an interface circuit, which inputs or outputs the electric signal, such as a sound signal, to the microphone 812 or from the speaker 813 under the control of the CPU 801. The microphone 812 and the speaker 813 may be a wirelessly connected headset.

The display 815 is an example of a display device that displays an image of a subject, various icons, etc. Examples of the display 518 include a liquid crystal display (LCD) and an organic electroluminescence (EL) display. The external device connection I/F 816 is an interface circuit for connecting the seller terminal 10 to various external devices, for example, in compliance with the universal serial bus (USB).

The vibrator 817 is a device that generates physical vibrations under the control of the CPU 801.

The touch panel 818 is an example of input device, which allows the user to touch a screen of the display 815 to cause the seller terminal 10 to perform various functions.

The CPU 801, the ROM 802, the RAM 803, the EEPROM 804, the imaging I/F 806, the acceleration-and-orientation sensor 807, the GNSS receiver 808, the long-range communication circuit 810, the short-range communication circuit 811, the audio I/O I/F 814, the display 815, the external device connection I/F 816, the vibrator 817, and the touch panel 818 are connected to each other via a bus line 809 such as an address bus or a data bus.

The hardware configuration of the seller terminal 10 illustrated in FIG. 4 is just one example, and the seller terminal 10 may not include all of the above-described components or may include other components.

### Hardware Configuration of Printer

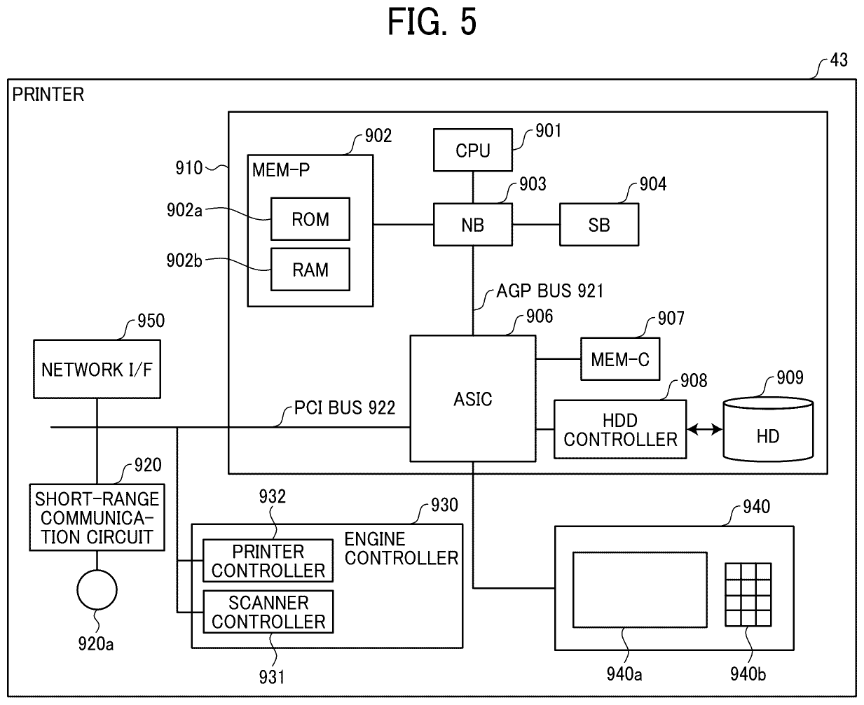

FIG. 5 is a diagram illustrating an example hardware configuration of the printer 43. The hardware configuration of the printer 43 is described with reference to FIG. 5.

As illustrated in FIG. 5, the printer 43 includes a controller 910, a short-range communication circuit 920, an engine controller 930, a control panel 940, and a network I/F 950.

The controller 910 includes a CPU 901 as a main processor, a system memory (MEM-P) 902, a northbridge (NB) 903, a southbridge (SB) 904, an Application Specific Integrated Circuit (ASIC) 906, a local memory (MEM-C) 907, a hard disk drive (HDD) controller 908, and a hard disk (HD) 909.

The NB 903 and the ASIC 906 are connected to each other by an accelerated graphics port (AGP) bus 921.

The CPU 901 controls entire operation of the printer 43. The NB 903 connects the CPU 901 to the MEM-P 902, the SB 904, and the AGP bus 921. The NB 903 includes a memory controller that controls reading or writing of various data from or to the MEM-P 902, a Peripheral Component Interconnect (PCI) master, and an AGP target.

The MEM-P 902 includes a ROM 902a, which is a memory for storing programs and data for implementing various functions of the controller 910, and a RAM 902b used as a storage area for deploying programs or data or a storage area for rendering print data. The program stored in the RAM 902b may be stored in any computer-readable storage medium, such as a compact disc-read only memory (CD-ROM), compact disc-recordable (CD-R), or digital versatile disc (DVD), in a file format installable or executable by the computer, for distribution.

The SB 904 is a bridge that connects the NB 903 to a PCI device or a peripheral device. The ASIC 906 is an Integrated Circuit (IC) dedicated to image processing, which has hardware elements for image processing, and connects the AGP bus 921, a PCI bus 922, the HDD controller 908, and the MEM-C 907 with one another. The ASIC 906 includes a PCI target, an AGP master, an arbiter (ARB) as a central processor of the ASIC 906, a memory controller for controlling the MEM-C 907, a plurality of Direct Memory Access Controllers (DMACs) capable of converting coordinates of image data with a hardware logic, and a PCI unit that transfers data between a scanner controller 931 and a printer controller 932 through the PCI bus 922. The ASIC 906 may be connected to a universal serial bus (USB) interface, or the Institute of Electrical and Electronics Engineers 1394 (IEEE1394) interface.

The MEM-C 907 is a local memory used as a buffer for an image to be copied or a buffer for coding. The HD 909 is a storage for storing image data, font data used in printing, and forms. The HDD controller 908 controls reading or writing of various data to or from the HD 909 under the control of the CPU 901. The HDD controller 908 and the HD 909 may be replaced by an SSD.

The AGP bus 921 is a bus interface for a graphics accelerator card, which has been proposed to accelerate graphics processing. Through directly accessing the MEM-P 902 by high throughput, the speed of the graphics accelerator card increases.

The short-range communication circuit 920 is a communication circuit in compliance with, for example, NFC or BLUETOOTH. The short-range communication circuit 920 is electrically connected to the ASIC 906 through the PCI bus 922. The short-range communication circuit 920 is provided with an antenna 920a for wireless communication.

The engine controller 930 includes the scanner controller 931 and the printer controller 932. Any one of the scanner controller 931 and the printer controller 932 performs various image processing, such as error diffusion or gamma conversion.

The control panel 940 includes a panel display 940a and a hard keypad 940b. The panel display 940a is implemented by, for example, a touch panel that displays current settings or a selection screen to receive a user input. The hard keypad 940b includes a numeric keypad that receives set values of various image forming parameters such as an image density parameter and a start key that receives an instruction for starting copying.

In response to an instruction to select a specific application through the control panel 940, for example, using a mode switch key, the printer 43 selectively performs a document box function, a copy function, a print function, and a facsimile communication function. When the document box function is selected, the printer 43 operates in a document box mode. When the copier function is selected, the printer 43 operates in a copy mode. When the printer function is selected, the printer 43 operates in a print mode. When the facsimile communication function is selected, the printer 43 operates in a facsimile communication mode.

The network I/F 950 is an interface circuit for performing data transmission via a network, in compliance with, for example, ETHERNET or TCP/IP. The network I/F 950 is electrically connected to the ASIC 906 through the PCI bus 922.

The hardware configuration of the information processing apparatus operating as the printer 43 illustrated in FIG. 5 is just one example, and the printer 43 may not include all of the components illustrated in FIG. 5, or may include any other hardware components.

### Functional Configuration and Operation of Information Processing System

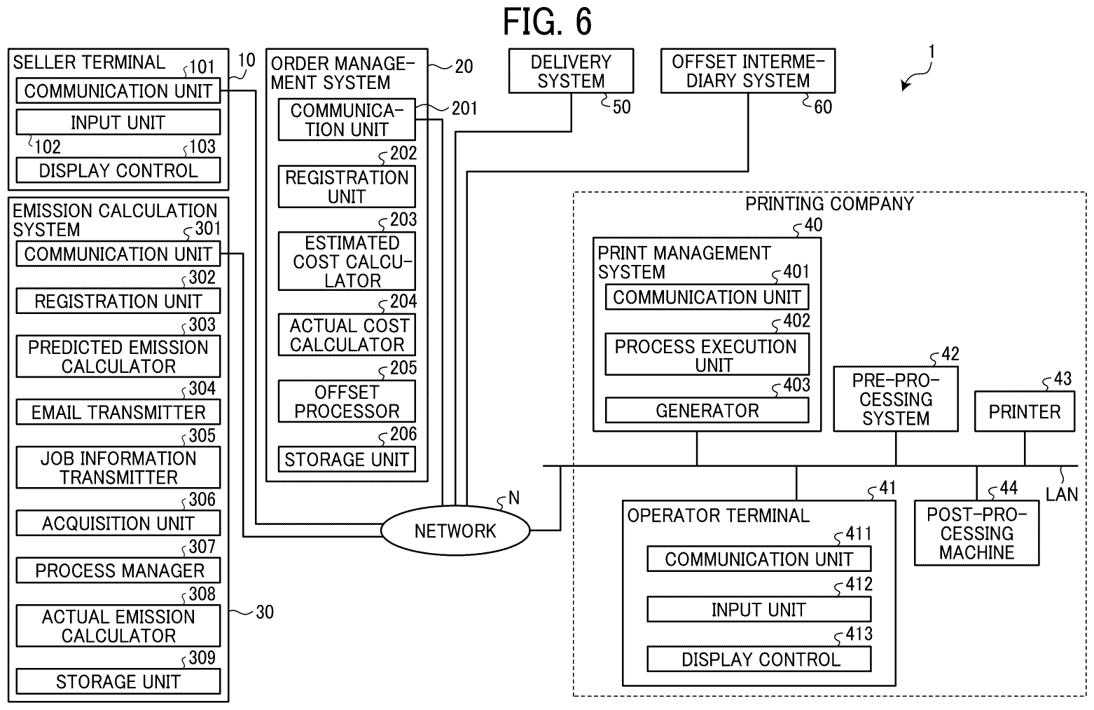

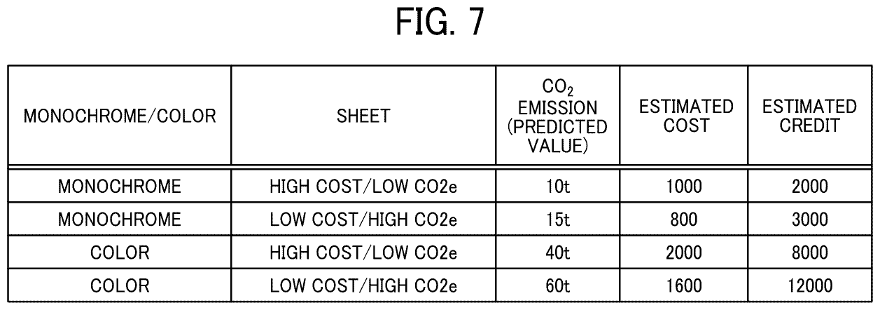

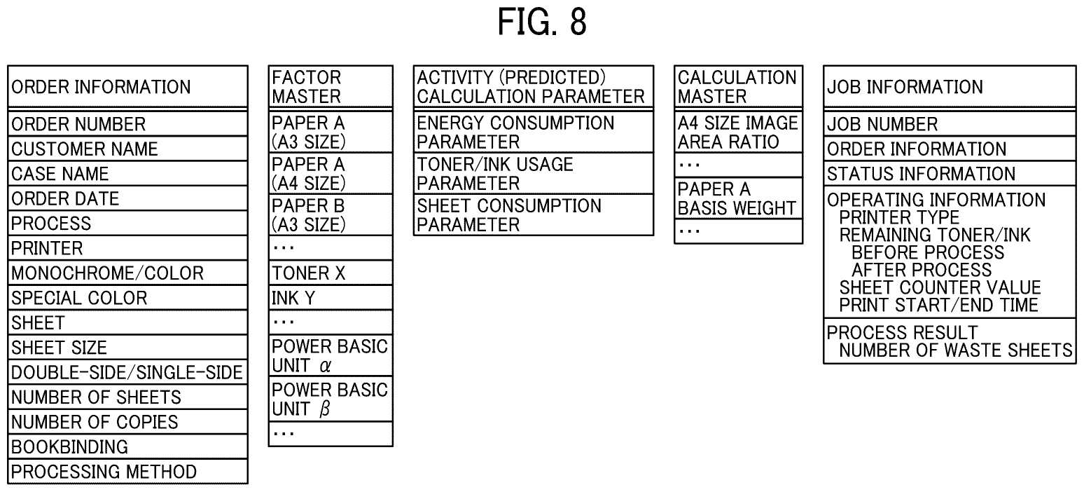

FIG. 6 is a diagram illustrating an example functional configuration of the information processing system 1. FIG. 7 is an example table storing the printing conditions, the amount of emissions, the estimated cost, and the estimated credit. FIG. 8 is a diagram illustrating an example structure of data processed by the information processing system 1. The functional configuration and the operation of the information processing system 1 is described with reference to FIGS. 6 to 8.

As illustrated in FIG. 6, the seller terminal 10 includes a communication unit 101, an input unit 102, and a display control 103.

The communication unit 101 is a functional unit that performs data communication with other devices via the long-range communication circuit 810. The communication unit 101 transmits, for example, the order information input by the input unit 102 to the order management system 20 through the network N.

The input unit 102 is a functional unit that receives an operation input from the user such as the sales representative. The sales representative enters order information, which is used for determining processes to be performed for producing the printed matter, via the input unit 102 in response to a request from the customer. FIG. 8 illustrates an example of data input as the order information. The input unit 102 is implemented by, for example, the touch panel 818 illustrated in FIG. 4.

The display control 103 is a functional unit that controls displaying operation performed by the display 815.

The communication unit 101 and the display control 103 described above are each implemented by the CPU 801 illustrated in FIG. 4 according to the program stored in any desired memory. The functions of the communication unit 101 and the display control 103 may be partly or entirely implemented by a hardware circuit (integrated circuit) such as a field-programmable gate array (FPGA) or an application specific integrated circuit (ASIC), in alternative to the CPU 801 that executes the software program.

The functional units of the seller terminal 10 illustrated in FIG. 6 are conceptual representations of the functions, and the functional units of FIG. 6 may be implemented in various other ways. For example, any combination of functional units, each described as an independent functional unit, in the seller terminal 10 illustrated in FIG. 6 may be configured as one functional unit. Alternatively, functions performed by one functional unit of the seller terminal 10 illustrated in FIG. 6 may be divided into a plurality of functions to constitute a plurality of functional units.

As illustrated in FIG. 6, the order management system 20 includes a communication unit 201 (an example of a first acquisition unit, an example of a second transmission unit), a registration unit 202, an estimated cost calculator 203 (a third calculation unit), an actual cost calculator 204, an offset processor 205, and a storage unit 206.

The communication unit 201 is a functional unit that performs data transmission with other devices via the network I/F 709, for example, to acquire, transmit, or receive various information such as the order information.

The registration unit 202 is a functional unit, which issues an order number in a case where the communication unit 201 receives the order information from the seller terminal 10, and registers the order information including the order number in the storage unit 206.

The estimated cost calculator 203 is a functional unit that calculates an estimated amount of cost incurred in the processes to be performed, based on the order information registered by the registration unit 202. The estimated cost calculator 203 calculates an estimated amount of credit (“the estimated credit”), which is used to offset a predicted value of carbon dioxide emissions. The predicted value of carbon dioxide emissions, which may simply be referred to as the predicted emission, is calculated by the emission calculation system 30 based on the order information. Using the predicted emission, the estimated cost calculator 203 calculates the estimated credit.

FIG. 7 illustrates example data of printing conditions, the amount of emissions, the estimated cost, and the estimated credit. FIG. 7 illustrates an example case in which the processes include a print process, which produces a printed matter as an example of a product. The printing conditions include the data items “monochrome/color” and “sheet”, but other printing conditions may be included. As illustrated in FIG. 7, if the printing conditions (an example of the processing conditions) change, the resultant estimated printing fee, i.e., the estimated cost, will be different. However, even if the estimated cost is made higher due to the printing conditions, the carbon dioxide emissions (that is, the predicted emission) generated by the printing process under such printing conditions is not necessarily high. For example, in the case where the monochrome/color setting is “monochrome” and the sheet setting is “high cost/low CO2e”, the emission is “10 tons (t)”, the estimated cost is “1000”, and the estimated credit is “2000”. In the case where the monochrome/color setting is “monochrome” and the sheet setting is “low cost/high CO2e”, the emission is “15t”, the estimated cost is “800”, and the estimated credit is “3000”. Even though the estimated cost of the latter case is lower, the emission of the latter case is higher, resulting in the higher estimated credit for offsetting for the latter case. The customer can select the printing conditions of the printed matter to be ordered, while taking into account not only the estimated cost such as the printing fee, but also the estimated credit based on the predicted emission.

The actual cost calculator 204 is a functional unit that calculates an actual fee (actual cost) charged for the processes performed, and the amount of credit charged for such processes, based on the activity value and the actual emission that are received from the emission calculation system 30 by the communication unit 201. The activity value indicates, for each process, an amount of work or processing that generates carbon dioxide emissions. For example, when the processes include a printing process, the amount of activity corresponds to, for example, the power consumption generated by operating the printer 43 and the post-processing machine 44, the amount of toner and the number of sheets consumed in the printing process, and the number of sheets discarded as waste paper. The waste paper is also referred to as damaged paper, and indicates paper to be discarded including paper on which printing has failed, paper on which test printing has been performed, etc. At the stage of estimating, the waste paper is sometimes referred to as spare paper. The amount of carbon dioxide emissions is calculated by multiplying the amount of activity (that is, the value of activity) by an emission factor. The emission factor indicates the amount of carbon dioxide emissions per unit amount of activity. FIG. 8 illustrates an example of an emission factor master, which manages an emission factor of each consumption item for the printing process. According to the emission factor master, the emission factor of “Paper A (A3 size)” indicates the amount of carbon dioxide emissions generated by a unit number of sheets of paper “Paper A” having the A3 size. The actual value of carbon dioxide emissions (“actual emission”) is calculated by multiplying the number of printed sheets, which is the activity, with the emission factor. To calculate the amount of carbon dioxide emission, a coefficient, such as a basis weight, managed by the calculation master illustrated in FIG. 8 is referred to and used as needed.

The offset processor 205 is a functional unit that executes processing related to offsetting with the offset intermediary system 60.

The storage unit 206 is a functional unit that stores such as the order information. The storage unit 206 is implemented by the auxiliary memory 705 illustrated in FIG. 3.

The communication unit 201, the registration unit 202, the estimated cost calculator 203, the actual cost calculator 204, and the offset processor 205 are implemented by the CPU 701 illustrated in FIG. 3 executing the program. The functions of the communication unit 201, the registration unit 202, the estimated cost calculator 203, the actual cost calculator 204, and the offset processor 205 may be partly or entirely implemented by a hardware circuit (integrated circuit) such as an FPGA or an ASIC, in alternative to the CPU 701 that executes the software program.

The functional units of the order management system 20 illustrated in FIG. 6 are conceptual representations of the functions, and the functional units of FIG. 6 may be implemented in various other ways. For example, any combination of functional units, each described as an independent functional unit, in the order management system 20 illustrated in FIG. 6 may be configured as one functional unit. Alternatively, functions performed by one functional unit of the order management system 20 illustrated in FIG. 6 may be divided into a plurality of functions to constitute a plurality of functional units.

As illustrated in FIG. 6, the emission calculation system 30 includes a communication unit 301, a registration unit 302, a predicted emission calculator 303 (second calculation unit), an email transmitter 304 (example of notification unit), a job information transmitter 305 (first transmission unit), an acquisition unit 306 (second acquisition unit), a process manager 307, an actual emission calculator 308 (first calculation unit), and a storage unit 309.

The communication unit 301 is a functional unit that performs data transmission with other devices via the network I/F 709.

The registration unit 302 is a functional unit, which issues a job number in a case where the communication unit 301 receives the order information from the order management system 20, and registers the order information and the job number in the storage unit 309 as the job information. The registration unit 302 may register the job information using a part of the order information or information associated with the order information.

The predicted emission calculator 303 is a functional unit that calculates a predicted value of carbon dioxide emissions. The predicted emission calculator 303 inputs past job information previously registered by the registration unit 302 to a learning model, and obtains the amount of activity as an output of the learning model. Using the predicted amount of activity obtained, the predicted emission calculator 303 calculate the predicted value of carbon dioxide emission for a new job, which is registered after the registration of the past job having been processed. The past job information is an example of first job information. The job information for the new job is an example of second job information. In this example, the predicted emission calculator 303 refers to the emission factor master and the calculation master of FIG. 8, which are stored in the storage unit 309, to calculate the predicted emission from the predicted activity. The job information is the job information registered by the registration unit 302 based on the order information, and has the same content as that of the order information received from the order management system 20. That is, the learning model receives the job information as an input and outputs a predicted amount of activity. The learning model is generated by performing machine learning on teacher data that is previously generated. In the teacher data, an actual amount of activity performed by executing the processes based on each job information, is labeled with respect to each of a plurality items of job information. Not all data items included in the job information are used as the teacher data, and only a part of the job information may be used as the teacher data. The learning model may not be configured to output the predicted amount of activity, but may be configured to learn to directly output the predicted value of carbon dioxide emissions. The learning model may be learned for each item of activity, such that the predicted amount of activity is output for each item.

Further, when there is a divergence (difference) between the predicted emission calculated by the predicted emission calculator 303 and the actual emission calculated by the actual emission calculator 308 to be described later, the predicted emission calculator 303 may adjust hyperparameters used for learning by the learning model and perform the learning again to update the learning model. The hyperparameters may be adjusted using, for example, the grid research technique. The predicted emission calculator 303 may determine to adjust the hyperparameters, for example, when the divergence (difference) between the predicted emission and the actual emission is equal to or greater than a predetermined threshold value. The predicted emission calculator 303 may adjust the hyperparameters according to the difference between the predicted emission and the actual emission described above or according to a manual instruction from an administrator (the process supervisor, for example). The hyperparameters are managed in the storage unit 309 as, for example, the activity (predicted) calculation parameter illustrated in FIG. 8.

The email transmitter 304 is a functional unit that transmits emails, to notify, for example, the seller terminal 10 or the operator terminal 41 via the communication unit 301. For example, the email transmitter 304 transmits, to the operator terminal 41 operated by the process supervisor, an email notifying that the order information has been received by the communication unit 301 from the order management system 20.

The job information transmitter 305 is a functional unit that transmits the job information to a system that manages and executes each process, when the job information is registered or updated in response to an operation on the operator terminal 41 by the process supervisor. For example, the job information transmitter 305 transmits the job information to the pre-processing system 42, the print management system 40, and the delivery system 50.

The acquisition unit 306 acquires the result information indicating the process result of each process, from the management apparatus (for example, the print management system 40, the pre-processing system 42, or the delivery system 50) that manages the execution of processing in each process. Examples of processing in each process include processing performed by the process operator of each process, and processing performed by the machine in operation. Examples of the result information include the process result information input by the process operator, and the operating information stored as the machine operates. The result information may further include information on procurement of raw materials to be used for producing products, information related to processing or manufacturing products, and information on delivery of products. The acquisition unit 306 is a functional unit that acquires, via the communication unit 301, process result information (an example of result information), which has been input by the process operator at the operator terminal 41, when each process is completed. The acquisition unit 306 further acquires the operating information indicating the result of operation (activity) performed by a specific apparatus, from the specific apparatus used in each process via the communication unit 301. For example, when the printing process is completed, the acquisition unit 306 acquires the operating information from the pre-processing system 42, and further acquires the operating information of the printer 43 and the post-processing machine 44 via the print management system 40. Examples of the process result information input to the operator terminal 41 include, for example, the number of waste sheets (damaged sheets) and the number of backup or adjustment sheets. Examples of the operating information of the printer 43 include the number of sheets consumed, and the amount of toner consumed.

The acquisition unit 306 stores the process result information and the operating information, which are acquired, in the storage unit 309.

The process manager 307 is a functional unit that manages each process. For example, the process manager 307 receives a process completion notification indicating that each process has been completed from the management apparatus (the print management system 40, the delivery system 50, etc.) that executes and manages each process. The process manager 307 further receives a job completion notification indicating that all processes according to the job information have been completed based on an operation performed on the operator terminal 41 by the process supervisor.

The actual emission calculator 308 is a functional unit that calculates the actual value of carbon dioxide emissions. The actual emission calculator 308 calculates the actual value of activity in each process based on the result information stored in the storage unit 309. The actual emission calculator 308 calculates the actual value of carbon dioxide emissions for the past job, from the actual value of activity in each process. The result information includes the process result information and the operating information. The past job is a job in which each process has been completed, and is an example of a job based on the first job information.

The storage unit 309 is a functional unit that stores the job information, the emission factor master, the calculation master, the hyperparameters of the learning model, the process result information, and the operating information. The hyperparameters include a parameter for calculating the activity (predicted value) illustrated in FIG. 8. The storage unit 309 is implemented by the auxiliary memory 705 illustrated in FIG. 3.

The communication unit 301, the registration unit 302, the predicted emission calculator 303, the email transmitter 304, the job information transmitter 305, the acquisition unit 306, the process manager 307, and the actual emission calculator 308 are implemented by the CPU 701 illustrated in FIG. 3 executing the program. The functions of the communication unit 301, the registration unit 302, the predicted emission calculator 303, the email transmitter 304, the job information transmitter 305, the acquisition unit 306, the process manager 307, and the actual emission calculator 308 may be partly or entirely implemented by a hardware circuit (integrated circuit) such as an FPGA or an ASIC, in alternative to the CPU 701 that executes the software program.

The functional units of the emission calculation system 30 illustrated in FIG. 6 are conceptual representations of the functions, and the functional units of FIG. 6 may be implemented in various other ways. For example, any combination of functional units, each described as an independent functional unit, in the emission calculation system 30 illustrated in FIG. 6 may be configured as one functional unit. Alternatively, functions performed by one functional unit of the emission calculation system 30 illustrated in FIG. 6 may be divided into a plurality of functions to constitute a plurality of functional units.

As illustrated in FIG. 6, the print management system 40 includes a communication unit 401, a process execution unit 402, and a generator 403.

The communication unit 401 is a functional unit that performs data transmission with other devices via the network I/F 709.

The process execution unit 402 is a functional unit that manages execution of the process based on the job information received by the communication unit 401. For example, the process execution unit 402 causes the printer 43 to execute the printing process and causes the post-processing machine 44 to execute the post-processing process based on the job information.

The generator 403 is a functional unit that acquires a job log indicating the content and the execution result of the job, from the printer 43 and the post-processing machine 44 via the communication unit 401. Using the job log, the generator 403 generates the operating information to be transmitted to the emission calculation system 30.

The communication unit 401, the process execution unit 402, and the generator 403 are implemented by the CPU 701, illustrated in FIG. 3, executing the program. The functions of the communication unit 401, the process execution unit 402, and the generator 403 may be partly or entirely implemented by a hardware circuit (integrated circuit) such as an FPGA or an ASIC, in alternative to the CPU 701 that executes the software program.

The functional units of the print management system 40 illustrated in FIG. 6 are conceptual representations of the functions, and the functional units of FIG. 6 may be implemented in various other ways. For example, any combination of functional units, each described as an independent functional unit, in the print management system 40 illustrated in FIG. 6 may be configured as one functional unit. Alternatively, functions performed by one functional unit of the print management system 40 illustrated in FIG. 6 may be divided into a plurality of functions to constitute a plurality of functional units.

As illustrated in FIG. 6, the operator terminal 41 includes a communication unit 411, an input unit 412, and a display control 413.

The communication unit 411 is a functional unit that performs data transmission with other devices via the network I/F 709. The communication unit 411 transmits, for example, the process result information input by the input unit 102 to the emission calculation system 30 through the network N.

The input unit 412 is a functional unit that receives an operation input from the user such as the process supervisor or the process operator. The input unit 412 is implemented by the keyboard 711 or the mouse 712 illustrated in FIG. 3.

The display control 413 is a functional unit that controls displaying operation performed by the display 708.

The communication unit 411 and the display control 413 described above are each implemented by the CPU 801 illustrated in FIG. 4 according to the program. The functions of the communication unit 411 and the display control 413 may be partly or entirely implemented by a hardware circuit (integrated circuit) such as an FPGA or an ASIC, in alternative to the CPU 801 that executes the software program.

The functional units of the operator terminal 41 illustrated in FIG. 6 are conceptual representations of the functions, and the functional units of FIG. 6 may be implemented in various other ways. For example, any combination of functional units, each described as an independent functional unit, in the operator terminal 41 illustrated in FIG. 6 may be configured as one functional unit. Alternatively, functions performed by one functional unit of the operator terminal 41 illustrated in FIG. 6 may be divided into a plurality of functions to constitute a plurality of functional units.

### Processing Order

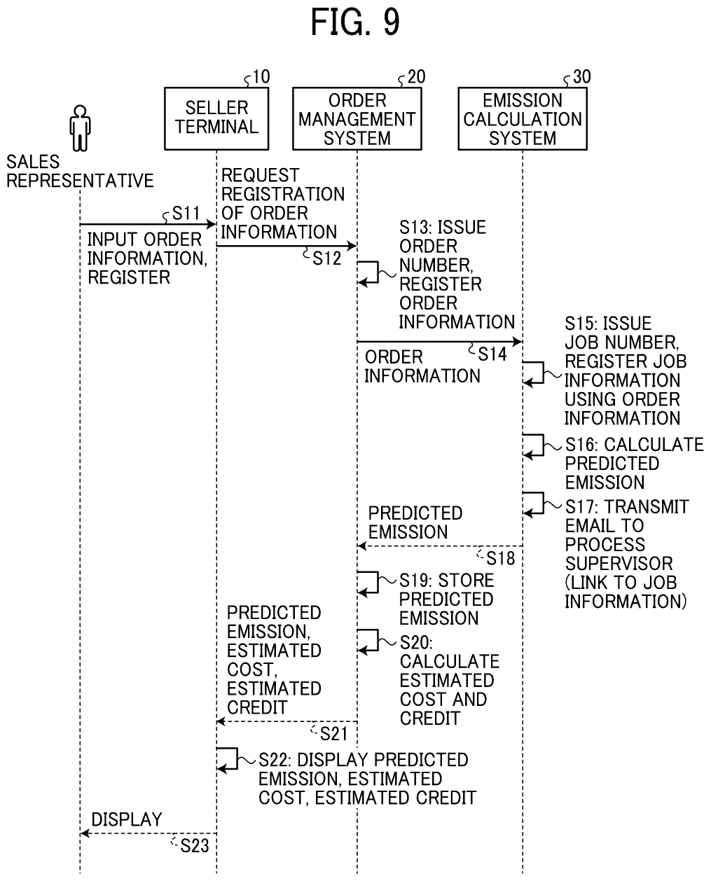

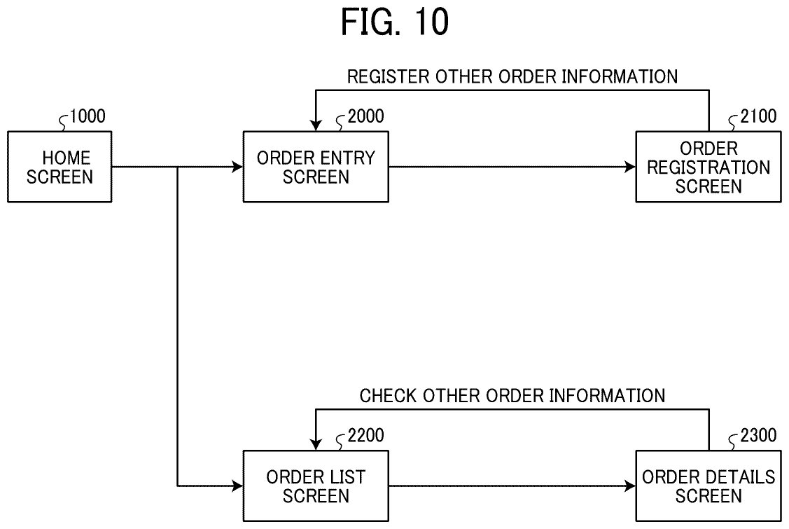

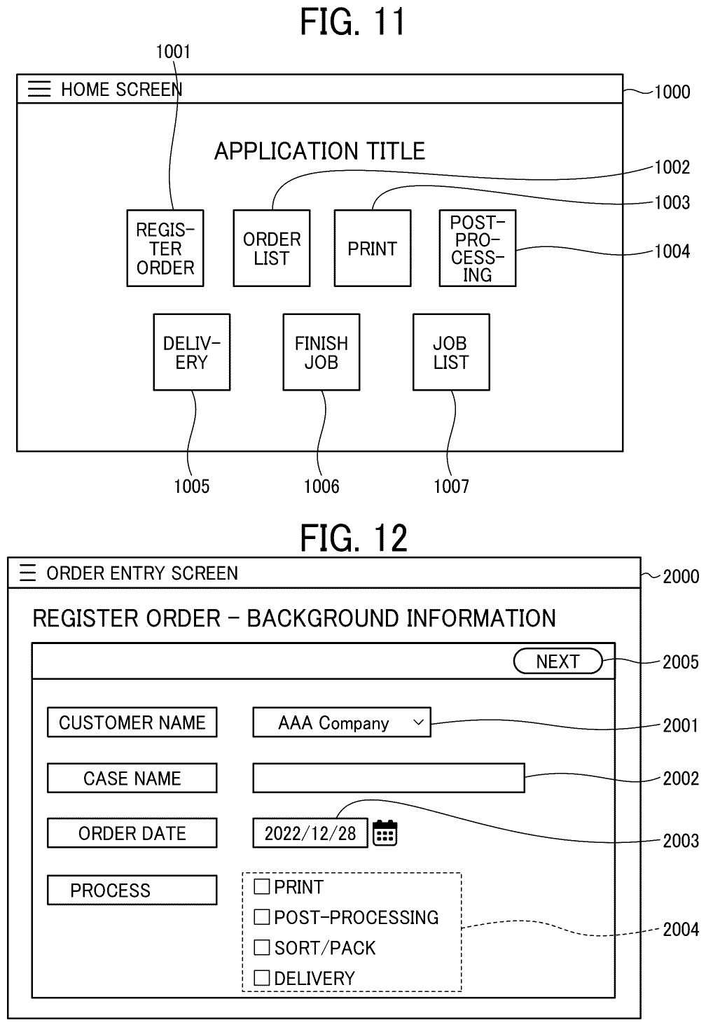

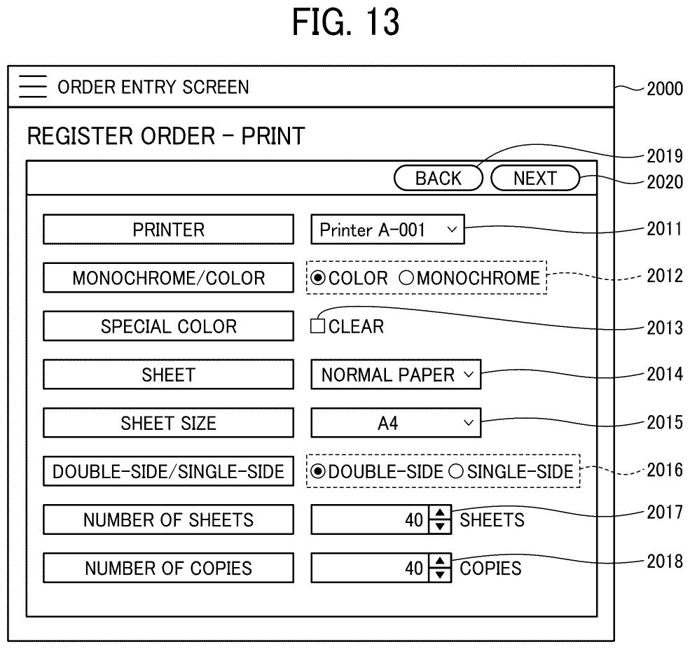

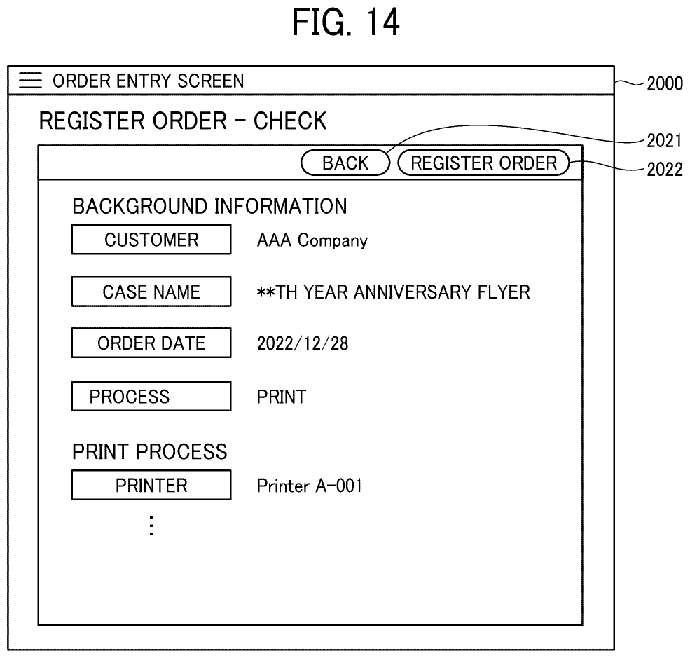

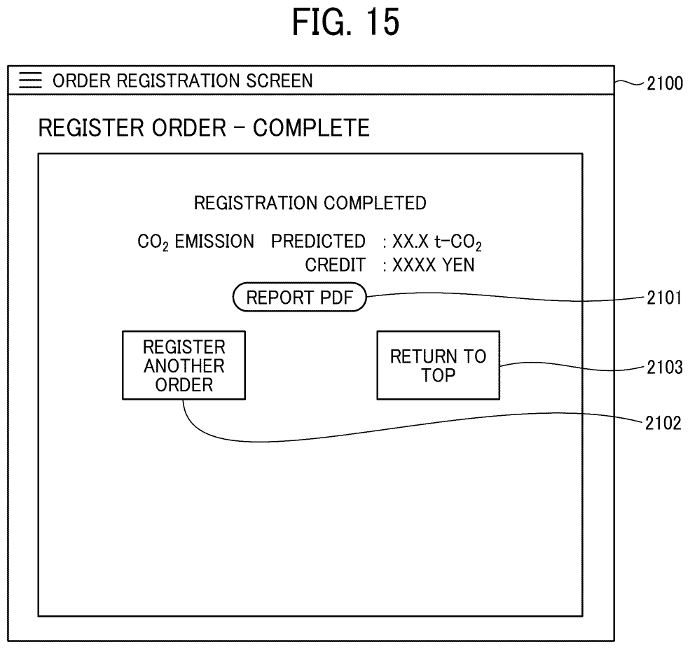

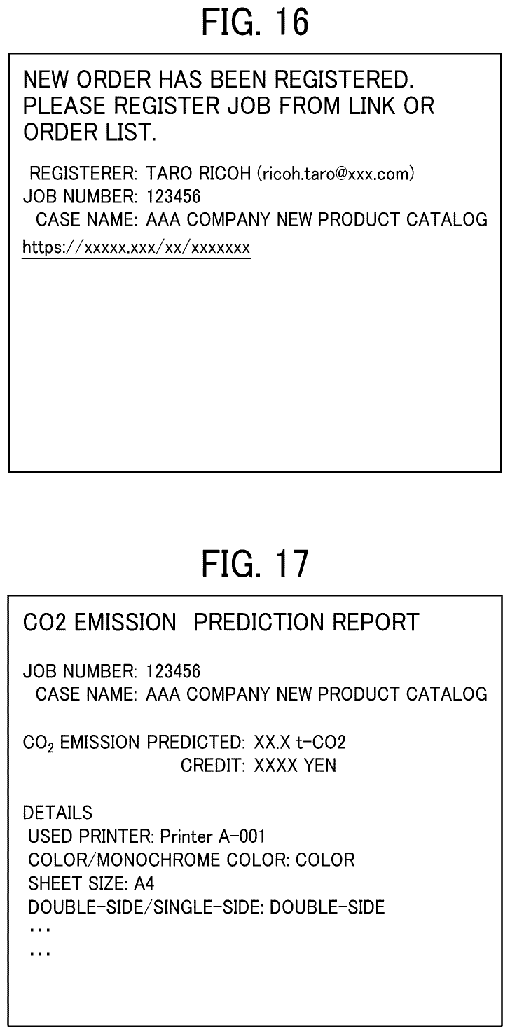

FIG. 9 is a sequence diagram illustrating example operation of processing an order, performed by the information processing system 1. FIG. 10 is a diagram illustrating an example of screen transitions when order processing is performed by the information processing system 1. FIG. 11 is an illustration of an example home screen, displayed by the information processing system 1. FIG. 12 is an illustration of an example order entry screen, displayed by the information processing system 1 when processing an order. FIG. 13 is an illustration of another example order entry screen, displayed by the information processing system 1 when processing an order. FIG. 14 is an illustration of another example order entry screen, displayed by the information processing system 1 when processing an order. FIG. 15 is an illustration of an example order registration screen, displayed by the information processing system 1 when processing an order. FIG. 16 is a diagram illustrating an example of email transmitted when order processing is performed by the information processing system 1. FIG. 17 is an illustration of an example report when order processing is performed by the information processing system 1. Referring to FIGS. 9 to 17, example operation of processing an order, performed by the information processing system 1, is described.

At S11, the sales representative operates the input unit 102 of the seller terminal 10 to display a home screen 1000 illustrated in FIG. 11 on the display 815.

The home screen 1000 illustrated in FIG. 11 may be transitioned to one of various screens including a screen for registering order information, a screen for updating registered job information, a screen for starting the process, a screen for completing job information, and a screen for confirming the result. As illustrated in FIG. 11, in this example, the home screen 1000 includes buttons 1001 to 1007, each of which causes screen transition.

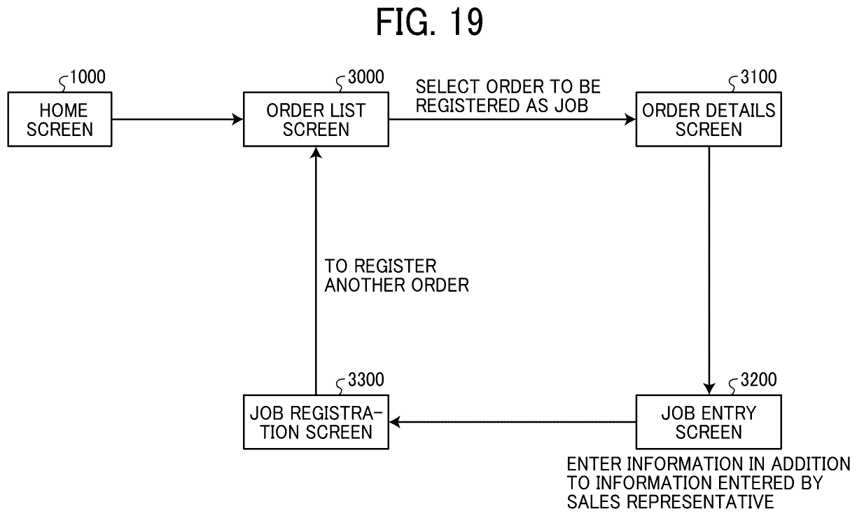

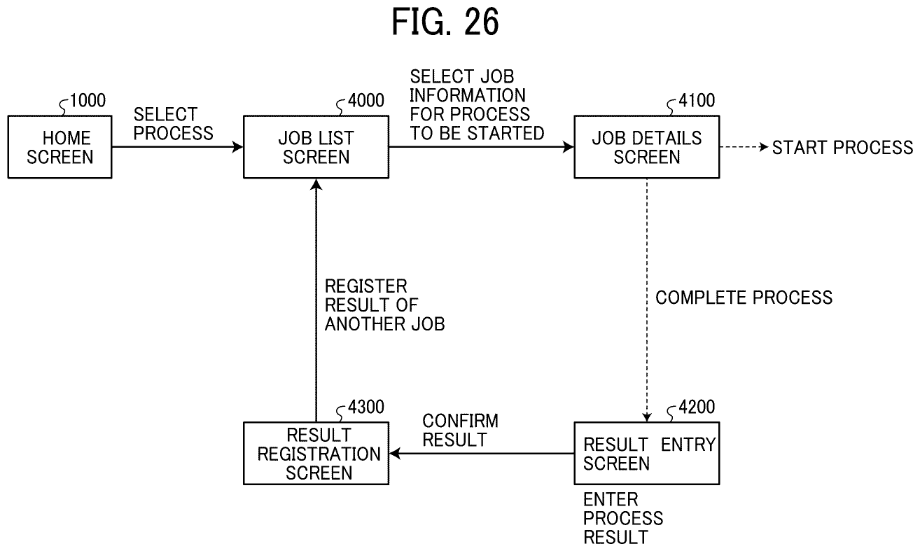

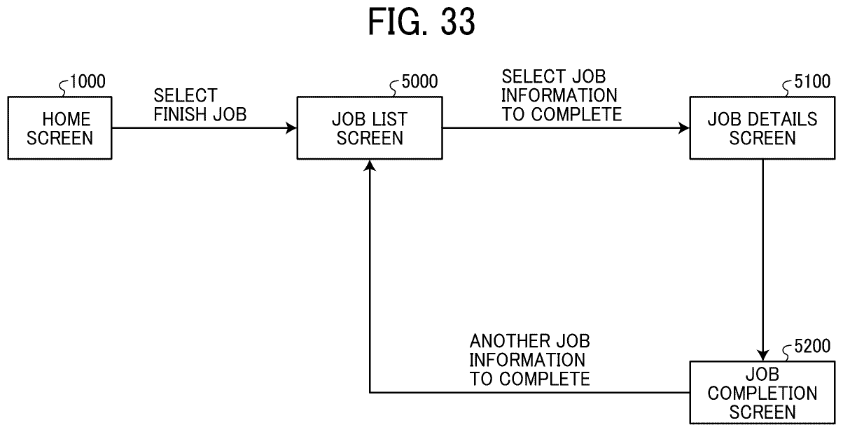

The “register order” button 1001 is a button for displaying an order entry screen 2000 of FIG. 12 for inputting order information. The “order list” button 1002 is a button for displaying an order list screen 2200 (FIG. 10) or an order list screen 3000 (FIG. 19). The order list screen 2200 is used to confirm a list of orders indicated by the order information registered by the seller terminal 10. At the operator terminal 41, the process supervisor edits or registers (or updates) the job information via the order list screen 3000. The “print” button 1003 is a button for displaying a job list screen 4000 (FIG. 26) for starting the printing process. The “post processing” button 1004 is a button for displaying a screen for starting the post-processing process. The “delivery” button 1005 is a button for displaying a screen for starting the delivery process. The “finish” button 1006 is a button for displaying a job list screen 5000 (FIG. 33) for completing all processes (jobs) based on the job information. The “job list” button 1007 is a button for displaying a result list screen 6000 (FIG. 37) for confirming the result of executing the job.

On the home screen 1000, all of the buttons 1001 to 1007 do not have to be displayed. For example, the buttons to be displayed on the home screen 1000 may be changed according to a role included in the user information of the user who has logged in. For example, if the sales representative has logged in, only the buttons 1001, 1002, and 1007 may be displayed on the home screen 1000.

When the sales representative presses the “register order” button 1001 using the input unit 102, the display control 103 of the seller terminal 10 displays the order entry screen 2000 of FIG. 12, as illustrated in FIG. 10.

The order entry screen 2000 of FIG. 12 is a screen for inputting background information of the order information in response to a request from the customer. As illustrated in FIG. 12, the order entry screen 2000 includes entry fields 2001 to 2003, check boxes 2004, and a next button 2005. The next button 2005 is a button for displaying the order entry screen 2000 illustrated in FIG. 13 for inputting, of the order information, the printing conditions in the printing process. The order entry screen 2000 illustrated in FIG. 13 includes an entry field 2011, a radio button 2012, a check box 2013, entry fields 2014 and 2015, radio buttons 2016, entry fields 2017 and 2018, a back button 2019, and a next button 2020.

Referring to FIG. 12, the entry field 2001 is an area for inputting a customer name. The entry field 2002 is an area for inputting the name of a case for which the order is received. The entry field 2003 is an area for inputting the date when the order is received. One or more of the check boxes 2004 are selected, which correspond to one or more processes to be performed to produce the printed matter as indicated by the order.

Referring to FIG. 13, the entry field 2011 is an area for inputting the model of the printer. The radio buttons 2012 are for designating a color of print output. Either color or monochrome is selected by selecting one of the radio buttons 2012. The check box 2013 is a check box for designating a special color (“clear” in the example of FIG. 13). The entry field 2014 is an area for selecting a type of paper. The entry field 2015 is an area for selecting a size of paper. The radio buttons 2016 are for selecting double-sided printing or single-sided printing. The entry field 2017 is an area for designating the number of sheets. The entry field 2018 is an area for designating the number of copies. The back button 2019 is a button that, when selected, returns to the order entry screen 2000 of FIG. 12 for entering background information. The next button 2020 is a button for transitioning to another order entry screen 2000 for inputting the conditions for the next process subsequent to the printing process. If there is no next process, when the next button 2020 is pressed, the screen is transitioned to the order entry screen 2000 illustrated in FIG. 14 for confirming the entered contents.

When the sales representative presses the next button 2020 using the input unit 102, the display control 103 displays the order entry screen 2000 illustrated in FIG. 14.

The order entry screen 2000 illustrated in FIG. 14 is a screen for confirming the contents of the entered order information. The order entry screen 2000 includes a back button 2021 and a register order button 2022, as illustrated in FIG. 14. The back button 2021 is a button for returning to a screen for inputting order information (for example, the order entry screen 2000 illustrated in FIG. 13). The register order button 2022 is a button for registering the entered order information.

At Step S12 of FIG. 9, in response to the sales representative pressing the register order button 2022 using the input unit 102, the communication unit 101 of the seller terminal 10 transmits the order information that is entered to the order management system 20. The communication unit 201 (an example of a first acquisition unit) of the order management system 20 receives the order information including the processing conditions of one or more processes for producing the product.

At S13, the registration unit 202 of order management system 20 issues an order number, and registers, with the order number, the order information received at the communication unit 201 in the storage unit 206. At S14, the communication unit 201 of the order management system 20 transmits the order information to the emission calculation system 30. The communication unit 301 of the emission calculation system 30 receives the order information.

At S15, the registration unit 302 of the emission calculation system 30 issues a job number, and registers the order information that is received at the communication unit 301 with the job number in the storage unit 309 as job information.

At S16, the predicted emission calculator 303 of the emission calculation system 30 inputs the job information registered by the registration unit 302 to the learning model as an input, and obtains the predicted value of activity as an output of the learning model. The predicted emission calculator 303 calculates the prediction value of carbon dioxide emissions using the predicted value of activity.

In this example, the predicted emission calculator 303 refers to the emission factor master and the calculation master of FIG. 8, which are stored in the storage unit 309, to calculate the predicted emission from the predicted activity.

The predicted emission calculator 303 may calculate the predicted value of emissions for each processing condition (printing condition, for example) of the process based on the job information.

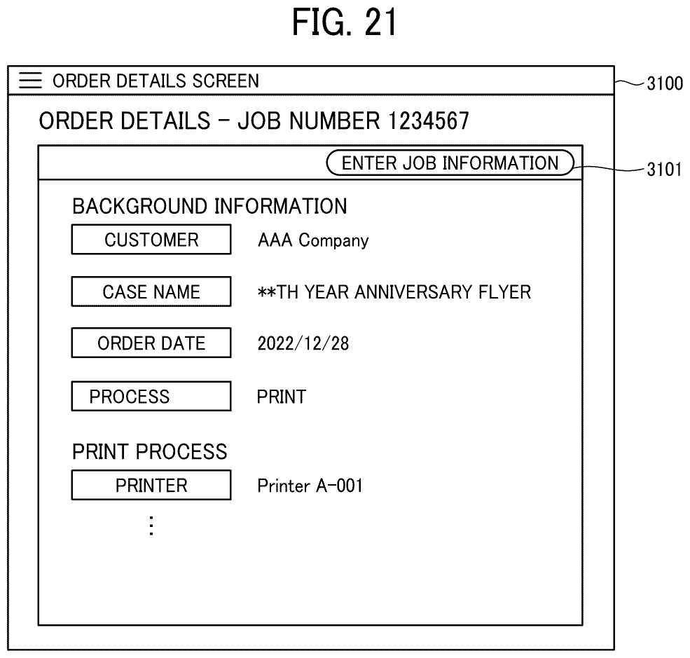

At S17, the email transmitter 304 transmits, to the operator terminal 41 operated by the process supervisor, an email notifying that the order information has been received by the communication unit 301 from the order management system 20. FIG. 16 illustrates example contents of the email transmitted by the email transmitter 304. The email illustrated in FIG. 16 includes, for example, a link for displaying an order details screen 3100 illustrated in FIG. 21, which will be described later, for the process supervisor to confirm the contents of the registered order information (job information). With the order details screen 3100, the process supervisor knows that the order information is received by the emission calculation system 30 and registered as the job information.

At S18, the communication unit 301 transmits the predicted emission, which is calculated by the predicted emission calculator 303, to the order management system 20. At S19, the communication unit 201 of the order management system 20 stores the predicted emission in the storage unit 206. In this case, the communication unit 201 may store the predicted emission in the storage unit 206 in association with the order information registered at S13.

At S20, the estimated cost calculator 203 of the order management system 20 calculates an estimated amount of cost incurred in the processes to be performed, based on the order information registered by the registration unit 202. The estimated cost calculator 203 calculates the estimated credit, which is used to offset a predicted value of the carbon dioxide emissions, based on the predicted emission calculated by the emission calculation system 30 based on the order information.

The estimated cost calculator 203 may calculate the estimated credit for each processing condition of the process based on the order information.

At S21, the communication unit 201 transmits the predicted emission, the estimated cost, and the estimated credit, to the seller terminal 10.

The communication unit 101 of the seller terminal 10 receives the predicted emission, the estimated cost, and the estimated credit.

At S22, the display control 103 of the seller terminal 10 displays an order registration screen 2100 of FIG. 15, which indicates the completion of registration of the order information as illustrated in FIG. 10. At S23, the order registration screen 2100 displays, for example, the predicted emission, the estimated cost, and the estimated credit, which are received at the communication unit 201.

As illustrated in FIG. 15, the order registration screen 2100 includes a “report PDF” button 2101, a “register another order” button 2102, and a “return to top” button 2103. The “report PDF” button 2101 is a button for displaying a report in Portable Document Format (PDF) as illustrated in FIG. 17, which displays the registered order information, the predicted emission, the estimated cost, and the estimated credit. The “register another order” button 2102 is a button for transitioning to another order entry screen 2000 to additionally register the order information. The “return to top” button 2103 is a button for returning to the home screen 1000.

As illustrated in FIG. 10, the sales representative can also cause the home screen 1000 to transition to the order list screen 2200 for checking a list of registered order information, and further cause the home screen 1000 to transition to the order details screen 2300 for checking details of the order information selected from the list.

### Job Registration

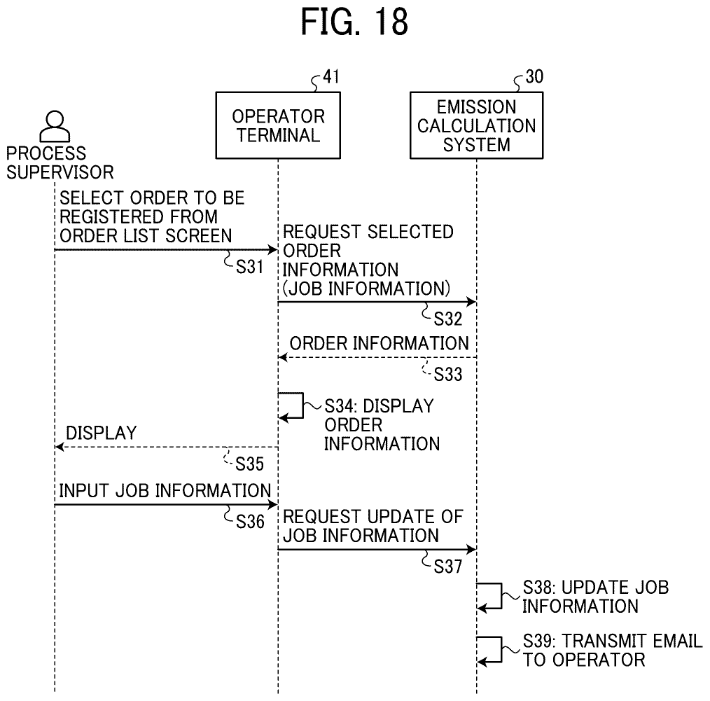

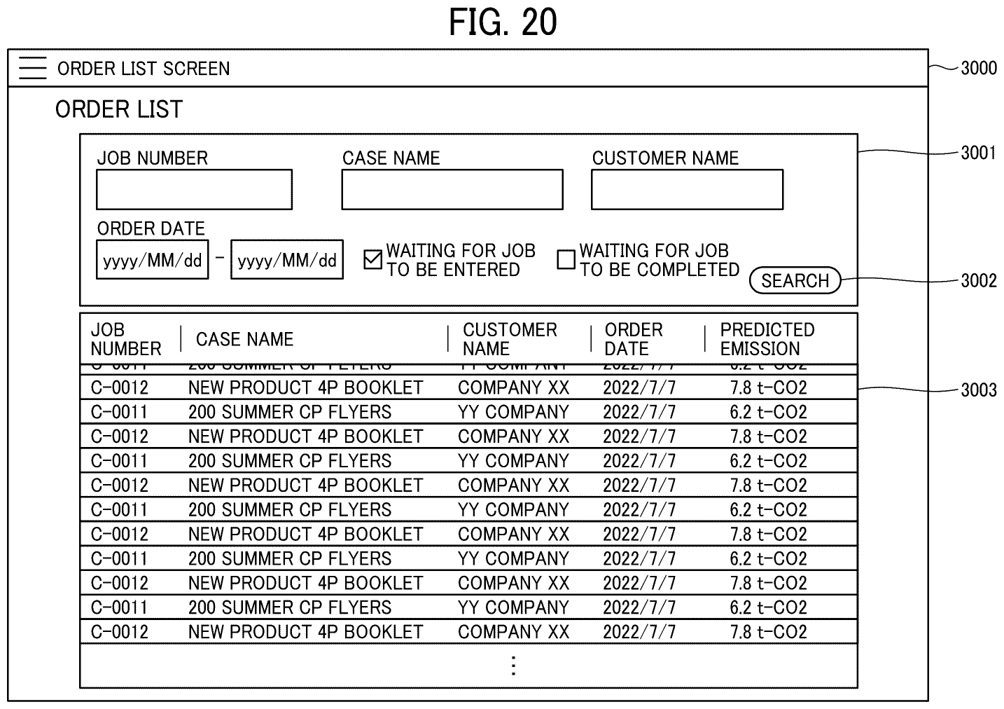

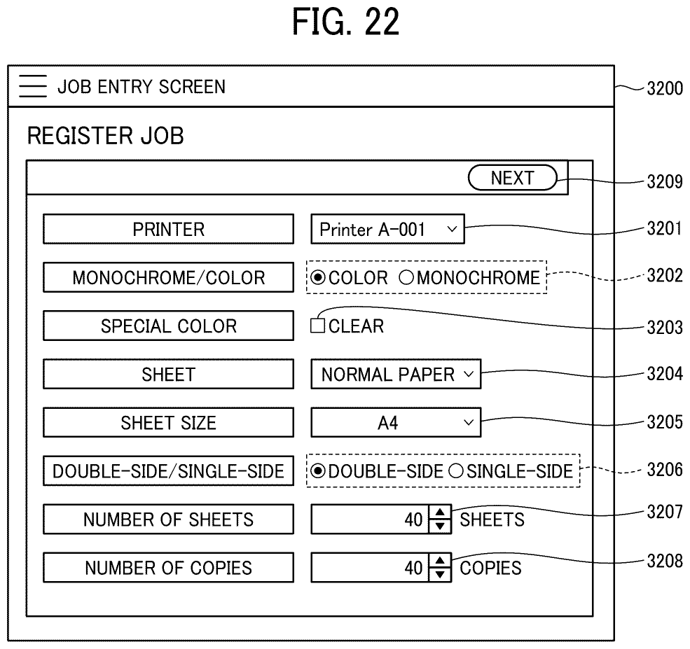

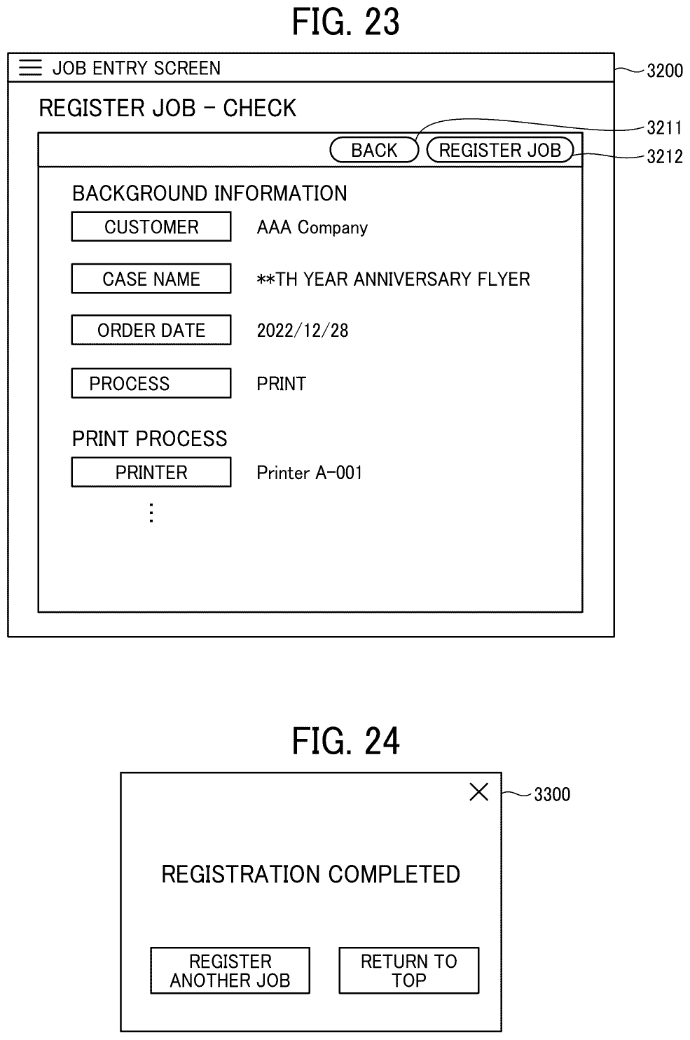

FIG. 18 is a sequence diagram illustrating example operation of registering a job, performed by the information processing system 1. FIG. 19 is a diagram illustrating an example of screen transitions when job registration is performed by the information processing system 1. FIG. 20 is an illustration of an example order list screen when job registration is performed by the information processing system 1. FIG. 21 is an illustration of an example order details screen when job registration is performed by the information processing system 1. FIG. 22 is an illustration of an example job entry screen when job registration is performed by the information processing system 1. FIG. 23 is an illustration of another example job entry screen when job registration is performed by the information processing system 1. FIG. 24 is an illustration of an example job registration screen when job registration is performed by the information processing system 1. Referring to FIGS. 9 to 24, example operation of registering a job, performed by the information processing system 1, is described.

At S31, in response to the process supervisor operating the input unit 412, the operator terminal 41 displays the home screen 1000 illustrated in FIG. 11 on the display 815. As illustrated in FIG. 19, in response to the process supervisor pressing the “order list” button 1002 using the input unit 412, the display control 413 of the operator terminal 41 displays the order list screen 3000 illustrated in FIG. 20.

The order list screen 3000 illustrated in FIG. 20 is a screen for displaying a list of the order information registered by the sales representative. The order information, which have been registered in the emission calculation system 30 as the job information, are associated with the job number. As illustrated in FIG. 20, the order list screen 3000 includes a search condition input area 3001, a search button 3002, and an order list display area 3003.

The search condition input area 3001 is an area for inputting a search condition for extracting desired order information from the list of order information displayed in the order list display area 3003. The search button 3002 is a button for extracting order information that matches the search condition input in the search condition input area 3001, and displaying a list of the extracted order information in the order list display area 3003. The order list display area 3003 is an area for displaying a list of the order information.

At S32, when the process supervisor selects the target order information from the list displayed in the order list display area 3003 using the input unit 412, the display control 413 transmits a request for acquiring the selected order information (job information) to the emission calculation system 30 via the communication unit 411. At S33, when the communication unit 301 of the emission calculation system 30 receives the acquisition request, the communication unit 301 reads the selected order information (job information) specified by the acquisition request from the storage unit 309, and transmits the read order information to the operator terminal 41. The communication unit 411 of the operator terminal 41 receives the order information.

At S34 and S35, the display control 413 of the operator terminal 41 displays the order details screen 3100 illustrated in FIG. 21, which displays the detailed contents of the order information received at the communication unit 411.

The process supervisor confirms the contents of the order information on the order details screen 3100.

The order details screen 3100 includes an “enter job information” button 3101 as illustrated in FIG. 21. The “enter job information” button 3101 is a button for displaying a job entry screen 3200 illustrated in FIG. 22, which allows adding, editing, and updating the contents of the order information displayed on the order details screen 3100.

As illustrated in FIG. 19, at S36, in response to the process supervisor pressing the “enter job information” button 3101 using the input unit 412, the display control 413 displays the job entry screen 3200 illustrated in FIG. 22 for adding, editing, or updating the contents of the order information.

As illustrated in FIG. 22, the job entry screen 3200 includes an entry field 3201, radio buttons 3202, a check box 3203, entry fields 3204 and 3205, radio buttons 3206, entry fields 3207 and 3208, and a next button 3209.

The entry field 3201 is an area for inputting or changing the model of the printer. The radio buttons 3202 are for designating or changing a color of print output. Either color or monochrome is selected by selecting one of the radio buttons 3202. The check box 3203 is a check box for designating or changing a special color (“clear” in the example of FIG. 22). The entry field 3204 is an area for selecting or changing a type of paper. The entry field 3205 is an area for selecting or changing a size of paper. The radio buttons 3206 are for selecting or changing double-sided printing or single-sided printing. The entry field 3207 is an area for designating or changing the number of sheets. The entry field 3208 is an area for designating or changing the number of copies. The next button 3209 is a button for displaying the job entry screen 3200 illustrated in FIG. 23, which allows confirmation of the job information (order information) that has been input or changed.

The job entry screen 3200 includes a back button 3211 and a “register job” button 3212, as illustrated in FIG. 23. The back button 3211 is a button for returning to the job entry screen 3200 of FIG. 22 to input or change the contents of the job information (order information). The “register job” button 3212 is a button for registering, or registering the update of, the job information with the contents displayed on the job entry screen 3200 illustrated in FIG. 23.

On the job entry screen 3200 illustrated in FIG. 22, the process supervisor inputs or changes the contents of the job information using the input unit 412 of the operator terminal 41 (second terminal). In response to the process supervisor pressing the next button 3209 using the input unit 412, the display control 413 displays the job entry screen of FIG. 23 for confirming the job information (order information) that has been input or changed. With the display of the job entry screen 3200, the process supervisor confirms the contents of the job information having been input or changed.

At S37, in response to the process supervisor pressing the “register job” button 3212 using the input unit 412, the communication unit 411 transmits the job information that is input or changed, and a request for updating the job information, to the emission calculation system 30. The communication unit 301 of the emission calculation system 30 receives the job information and the update request.

At S38, the registration unit 302 of the emission calculation system 30 registers the updated job information in the storage unit 309 in response to the update request received at the communication unit 301. In this case, the communication unit 301 of the emission calculation system 30 may transmit a notification that the job information is registered (or updated) to the operator terminal 41. When the communication unit 411 receives the notification that the job information has been registered (or updated), the display control 413 displays the job registration screen 3300 illustrated in FIG. 24 indicating that the job information has been registered (or updated), as illustrated in FIG. 19.

When the job information is updated, the predicted emission calculator 303 may input the updated job information to the learning model as an input again to obtain the predicted value of activity as an output. The predicted emission calculator 303 then calculates the prediction value of carbon dioxide emissions again using the obtained prediction value of activity.

At S39, the email transmitter 304 of the emission calculation system 30 transmits an email notifying that the job information has been registered (or updated) to the operator terminal 41 of the process operator. With this notification, the process operator knows that the job information for which the process is to be started is registered (or updated).

### Executing Process and Entering Result

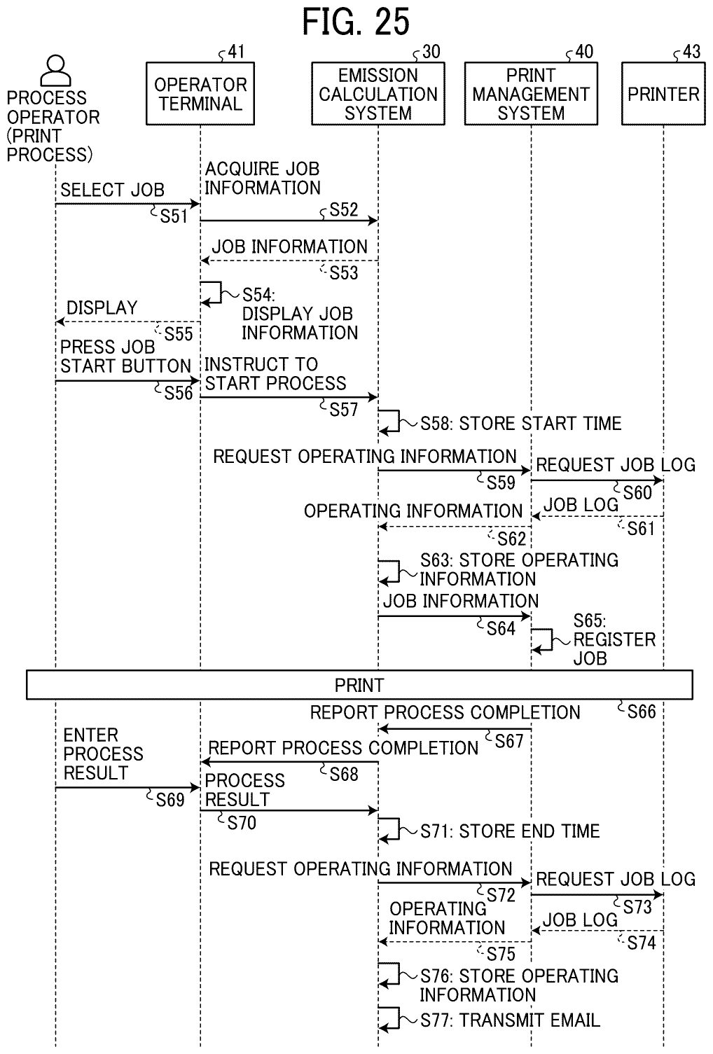

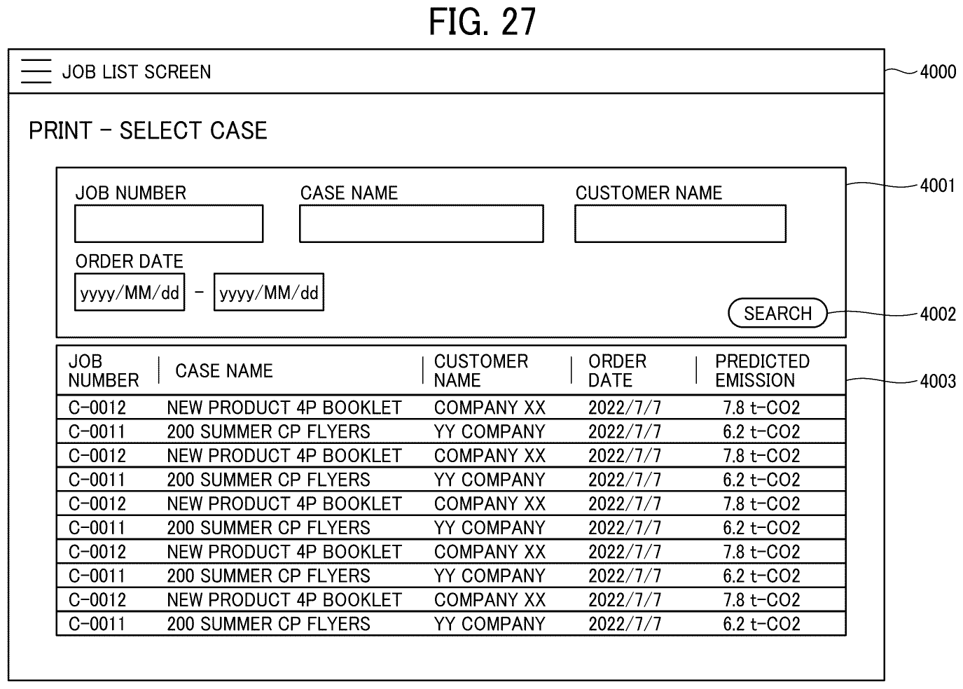

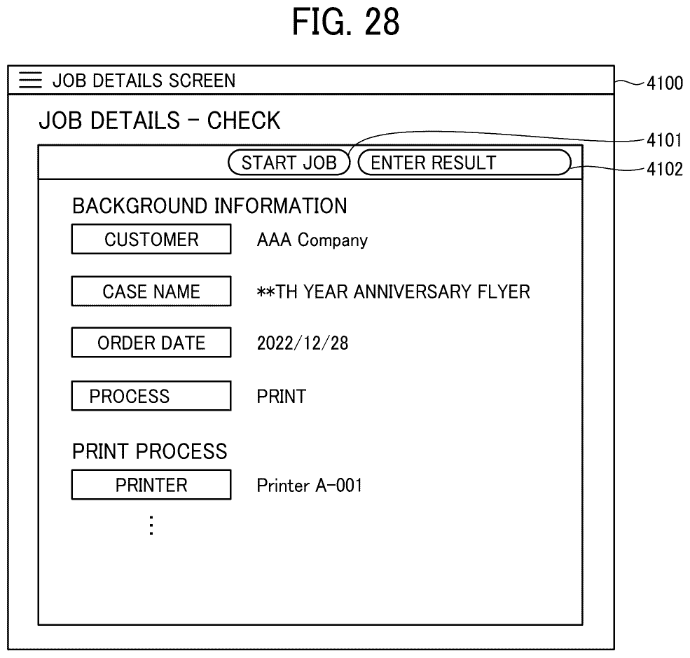

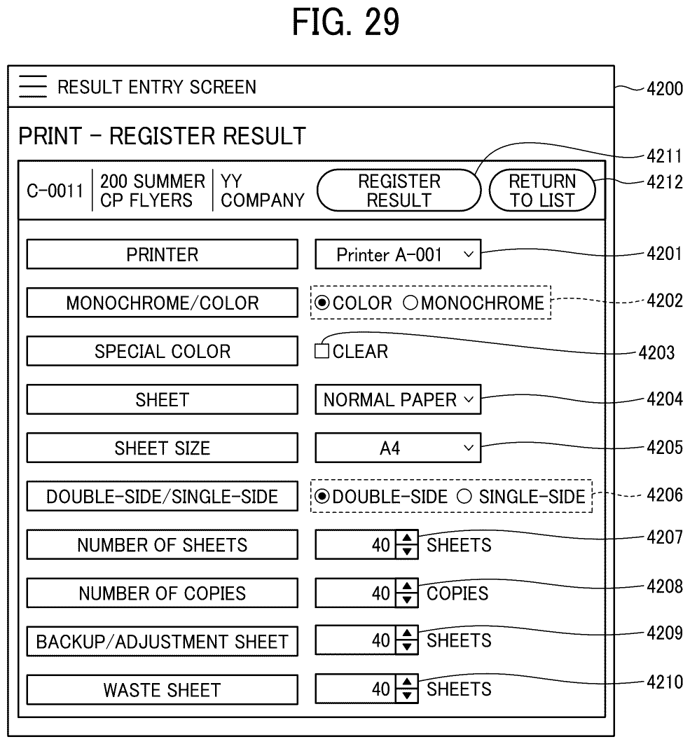

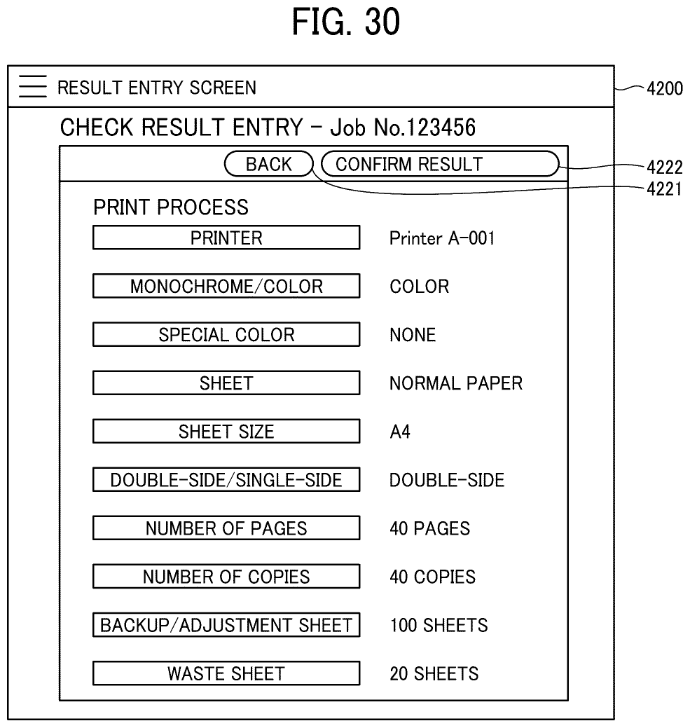

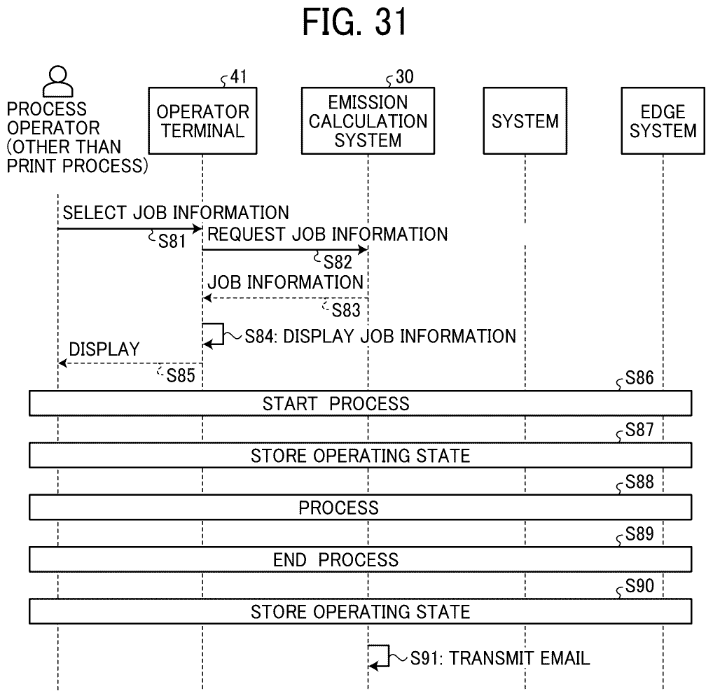

FIG. 25 is a sequence diagram illustrating example operation of executing a process and entering a result of the process, performed by the information processing system 1. FIG. 26 is a diagram illustrating an example of screen transitions when processing to execute the process and enter the result is performed by the information processing system 1. FIG. 27 is an illustration of an example job list screen when processing to execute the process and enter the result is performed by the information processing system 1. FIG. 28 is an illustration of an example job details screen when processing to execute the process and enter the result is performed by the information processing system 1. FIG. 29 is an illustration of an example result entry screen when processing to execute the process and enter the result is performed by the information processing system 1. FIG. 30 is an illustration of another example result entry screen when processing to execute the process and enter the result is performed by the information processing system 1. FIG. 31 is a sequence diagram illustrating another example operation of executing a process and entering a result of the process, performed by the information processing system 1. Referring to FIGS. 25 to 31, example operation of executing the process and entering the process result, performed by the information processing system 1, is described. First, the operation of executing the printing process and entering the result of the printing process is described with reference to FIG. 25.

At S51, in response to the process operator operating the input unit 412, the operator terminal 41 displays the home screen 1000 illustrated in FIG. 11 on the display 815. As illustrated in FIG. 26, in response to the process operator pressing the “print” button 1003 using the input unit 412, the display control 413 of the operator terminal 41 displays the job list screen 4000 illustrated in FIG. 27.

The job list screen 4000 illustrated in FIG. 27 is a screen for displaying a list of job information having been registered (or updated) by the process supervisor. In other words, the screen of FIG. 27 displays the job information for which the process can be started. As illustrated in FIG. 27, the job list screen 4000 includes a search condition input area 4001, a search button 4002, and a job list display area 4003.

The search condition input area 4001 is an area for inputting a search condition for extracting desired job information from the list of job information displayed in the job list display area 4003. The search button 4002 is a button for extracting job information that matches the search condition input in the search condition input area 4001, and displaying a list of the extracted job information in the job list display area 4003. The job list display area 4003 is an area for displaying a list of the job information.

The process operator selects job information for which the process (for example, the printing process) is to be started, from the job list display area 4003, using the input unit 412.

At S52, when the process operator selects the target job information for which the printing process is to be started, from the list displayed in the job list display area 4003 using the input unit 412, the display control 413 transmits a request for acquiring the selected job information to the emission calculation system 30 via the communication unit 411. At S53, when the communication unit 301 of the emission calculation system 30 receives the acquisition request, the communication unit 301 reads the selected job information specified by the acquisition request from the storage unit 309, and transmits the read job information to the operator terminal 41. The communication unit 411 of the operator terminal 41 receives the job information.

At S54 and S55, the display control 413 of the operator terminal 41 displays the job details screen 4100 illustrated in FIG. 28, which displays the detailed contents of the job information received at the communication unit 411.

The process operator confirms the contents of the job information on the job details screen 4100.

As illustrated in FIG. 28, the job details screen 4100 includes a “start job” button 4101 and an “enter result” button 4102. The “start job” button 4101 is a button for starting the process (for example, the printing process) based on the displayed job information. The “enter result” button 4102 is a button for entering the process result after execution of the process is completed.

At S56 and S57, in response to the process operator pressing the “start job” button 4101 using the input unit 412, the communication unit 411 transmits an instruction to start the printing process (“process start instruction”) based on the selected job information to the emission calculation system 30.

The communication unit 301 of the emission calculation system 30 receives the process start instruction.

At S58, the process manager 307 of the emission calculation system 30 stores a start time, which is the time at which the process start instruction is received at the communication unit 301, in the storage unit 309.

At S59, the acquisition unit 306 of the emission calculation system 30 transmits a request for acquiring operating information of the printer 43 and the post-processing machine 44 to the print management system 40 via the communication unit 301. At S60, when the communication unit 401 of the print management system 40 receives the request for acquiring operating information from the emission calculation system 30, the communication unit 401 transmits a request for acquiring a job log indicating a history of operations and processes to the printer 43 and the post-processing machine 44.

At S61, when the printer 43 and the post-processing machine 44 receive the request for acquiring the job log, the printer 43 and the post-processing machine 44 collect the job log and transmit the job log to the print management system 40.

At S62, the generator 403 of the print management system 40 generates operating information to be transmitted to the emission calculation system 30, from the job log received at the communication unit 401. The operating information includes, for example, at least one of the number of sheets remaining in the printer 43 and the amount of toner or ink remaining in the printer 43. The communication unit 401 transmits the operating information generated by the generator 403 to the emission calculation system 30. The communication unit 301 of the emission calculation system 30 receives the operating information.

At S63, the communication unit 301 stores the operating information in the storage unit 309.

At S64, the job information transmitter 305 of the emission calculation system 30 transmits job information corresponding to the process start instruction received at S57 to the print management system 40 via the communication unit 301. The communication unit 401 of the print management system 40 receives the job information.

At S65, the process execution unit 402 of the print management system 40 registers the job information received at the communication unit 401.

At S66, the printing process (printing operation) is executed. Depending on the printing conditions, the post-processing process may be executed on the printed sheet. After the job information is received at the communication unit 401 of the print management system 40, the process execution unit 402 may cause the printer 43 and the post-processing machine 44 to automatically execute a series of the printing process and the post-processing process based on the job information. Alternatively, the process execution unit 402 may cause the printer 43 and the post-processing machine 44 to execute the printing process and the post-processing process based on the job information, in response to an instruction from the process operator.

At S67, when the printing process is completed, the process execution unit 402 transmits a notification indicating that the printing process is completed (“process completion notification”) to the emission calculation system 30 via the communication unit 401. The communication unit 301 of the emission calculation system 30 receives the process completion notification.

At S68, the communication unit 301 of the emission calculation system 30 transmits the process completion notification to the operator terminal 41. The communication unit 301 may transmit the process completion notification in the form of an email to the operator terminal 41.

At S69, the process operator presses the “enter result” button 4102 on the job details screen 4100 that displays the details of the job information corresponding to the process completion notification (that is, the job information for which the process has been completed). As illustrated in FIG. 26, the display control 413 of the operator terminal 41 (an example of the second terminal) displays a result entry screen 4200 illustrated in FIG. 29 for inputting the process result obtained by executing the process (for example, the printing process).

As illustrated in FIG. 29, the result entry screen 4200 includes an entry field 4201, radio buttons 4202, a check box 4203, entry fields 4204 and 4205, radio buttons 4206, entry fields 4207 to 4210, a “register result” button 4211, and a “return to list” button 4212.

The entry field 4201 is an area for inputting or changing the model of the printer. The radio buttons 4202 are for designating or changing a color of print output. Either color or monochrome is selected by selecting one of the radio buttons 4202. The check box 4203 is a check box for designating or changing a special color (“clear” in the example of FIG. 29). The entry field 4204 is an area for selecting or changing a type of paper. The entry field 4205 is an area for selecting or changing a size of paper. The radio buttons 4206 are for selecting or changing double-sided printing or single-sided printing. The entry field 4207 is an area for designating or changing the number of sheets. The entry field 4208 is an area for designating or changing the number of copies. When the information is changed due to inevitable circumstances in the printing process from the initially registered job information, the printing conditions, which correspond to the information entered in any one of the entry fields 4201 to 4208, may be updated to reflect the changed contents. The entry field 4209 is an area for inputting the number of sheets, which are used as the backup or adjustment sheets and charged to the customer. The entry field 4210 is an area for inputting the number of sheets used as waste paper (damaged paper), and the costs will be absorbed by the printing company. The “register result” button 4211 is a button for displaying a result entry screen 4200 illustrated in FIG. 30 for confirming the process result information indicating the result of executing the process. The “return to list” button 4212 is a button for returning to the job list screen 4000.

As illustrated in FIG. 30, the result entry screen 4200 includes a back button 4221 and a “confirm result” button 4222. The back button 4221 is a button for returning to the result entry screen 4200 illustrated in FIG. 29. The “confirm result” button 4222 is a button for confirming and registering the process result information entered via the result entry screen 4200 illustrated in FIG. 29.

The process operator enters the process result to the result entry screen 4200 illustrated in FIG. 29 using the input unit 412. When the “register result” button 4211 is pressed by the process operator using the input unit 412, the display control 413 displays the result entry screen 4200 illustrated in FIG. 30 for confirming the process result information. The process operator confirms the contents of the entered process result information, which is displayed on the result entry screen 4200.

At S70, the process operator presses the “confirm result” button 4222 on the result entry screen 4200 illustrated in FIG. 30. The communication unit 411 of the operator terminal 41 transmits the process result information to the emission calculation system 30. The communication unit 301 of the emission calculation system 30 receives the process result information.

At S71, the process manager 307 of the emission calculation system 30 stores the time (end time) when the process result information is received by the communication unit 301, and the process result information, in the storage unit 309.

In this case, the communication unit 301 may transmit, to the operator terminal 41, a notification indicating that the process result information is stored in the storage unit 309. When the communication unit 411 receives the notification indicating that the process result information has been stored, the display control 413 displays a result registration screen 4300 indicating that the process result information has been stored (registered), as illustrated in FIG. 26.

At S72, the acquisition unit 306 of the emission calculation system 30 transmits a request for acquiring operating information of the printer 43 and the post-processing machine 44 to the print management system 40 via the communication unit 301. At S73, when the communication unit 401 of the print management system 40 receives the request for acquiring operating information from the emission calculation system 30, the communication unit 401 transmits a request for acquiring a job log indicating a history of operations and processes to the printer 43 and the post-processing machine 44.

At S74, when the printer 43 and the post-processing machine 44 receive the request for acquiring the job log, the printer 43 and the post-processing machine 44 collect the job log and transmit the job log to the print management system 40.

At S75, the generator 403 of the print management system 40 generates operating information to be transmitted to the emission calculation system 30, from the job log received at the communication unit 401. The operating information includes, for example, at least one of the number of sheets remaining in the printer 43, the amount of toner or ink remaining in the printer 43, and the power consumption. The communication unit 401 transmits the operating information generated by the generator 403 to the emission calculation system 30. The communication unit 301 of the emission calculation system 30 receives the operating information.

At S76, the communication unit 301 stores the operating information in the storage unit 309.

At S77, the email transmitter 304 of the emission calculation system 30 transmits an email indicating that the operating information and the process result information in the printing process are stored (registered), to the operator terminal 41 operated by the process operator for the next process. Such email indicates that the printing process is completed, so that the next process can be started. The above-described notification may be sent in various ways other than the email transmission by the email transmitter 304.

Referring now to FIG. 31, example operation of executing the process and entering the process result, other than the printing process, is described. In this example, the system is an example of management apparatus, which manages operation performed by the edge system.

At S81, in response to the process operator operating the input unit 412, the operator terminal 41 displays the home screen 1000 illustrated in FIG. 11 on the display 815. When the process operator presses a button corresponding to a desired process using the input unit 412, the display control 413 of the operator terminal 41 displays a job list screen that displays a list of job information corresponding to the process. The process operator selects job information for which the process is to be started, from the job list display area 4003, using the input unit 412.

The processing of S82 to S85 are performed in a substantially similar manner as the processing of S52 to S55 illustrated in FIG. 25.

At S86, execution of the process starts as described above referring to S56 and S57 illustrated in FIG. 25.

At S87, the operating information is acquired and stored as described above referring to S58 to S65 illustrated in FIG. 25.

At S88, the process is executed in a substantially similar manner as described above referring to S66 of FIG. 25.

At S89, similarly to S67 to S70 illustrated in FIG. 25, the process completion notification is transmitted, and the process result is entered.

At S90, the operating information is acquired and stored, in a similar manner as described above referring to S71 to S76 illustrated in FIG. 25.

At S91, the email transmitter 304 of the emission calculation system 30 transmits an email indicating that the operating information and the process result information in the process are stored (registered), to the operator terminal 41 operated by the process operator for the next process.

### Job Completion

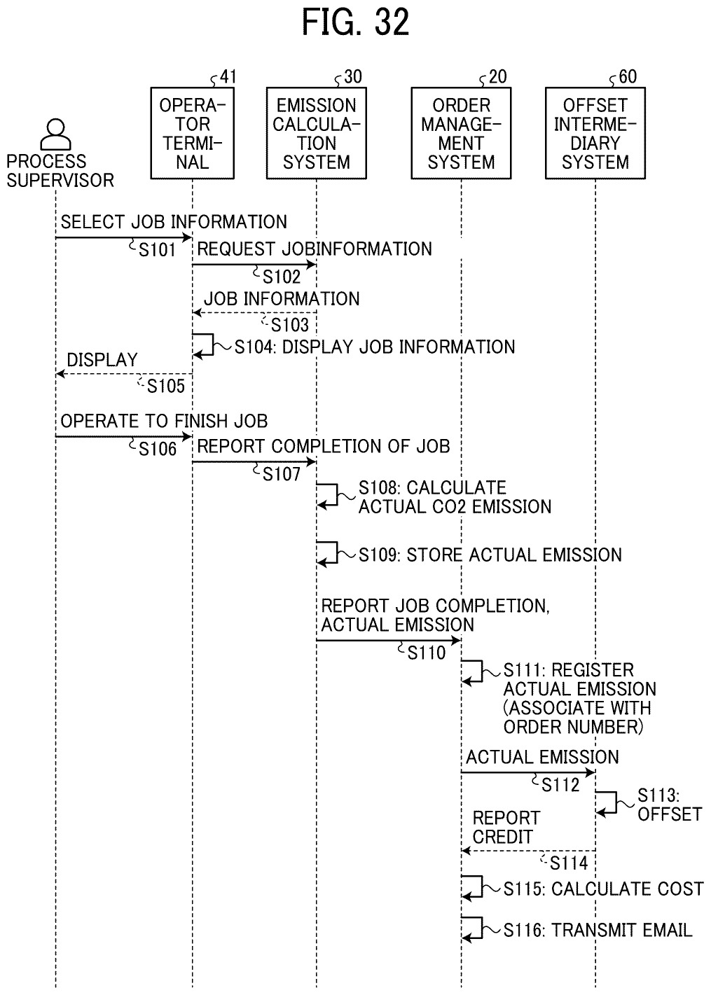

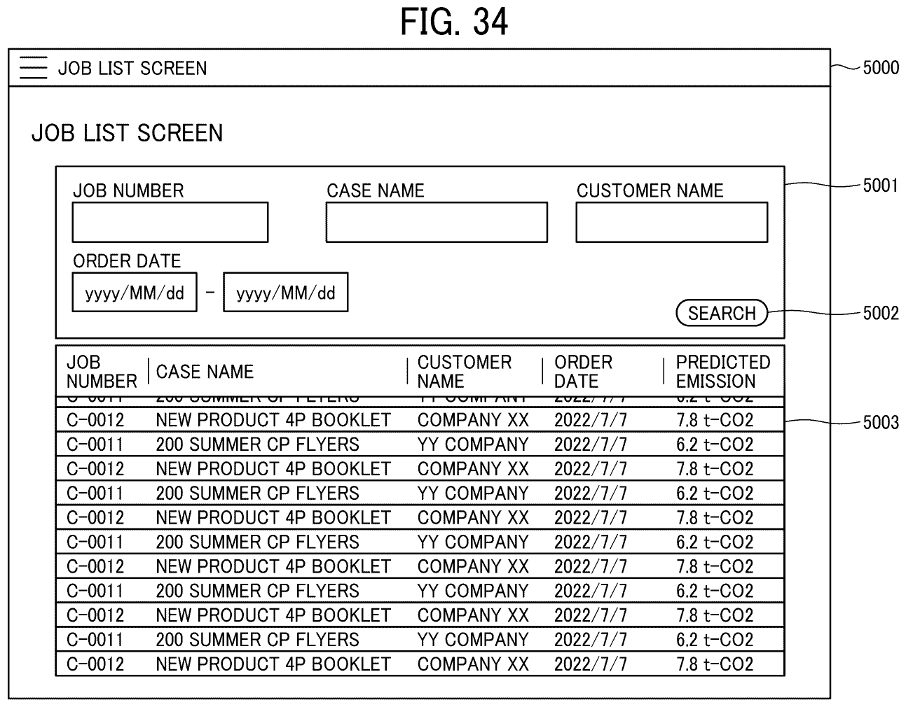

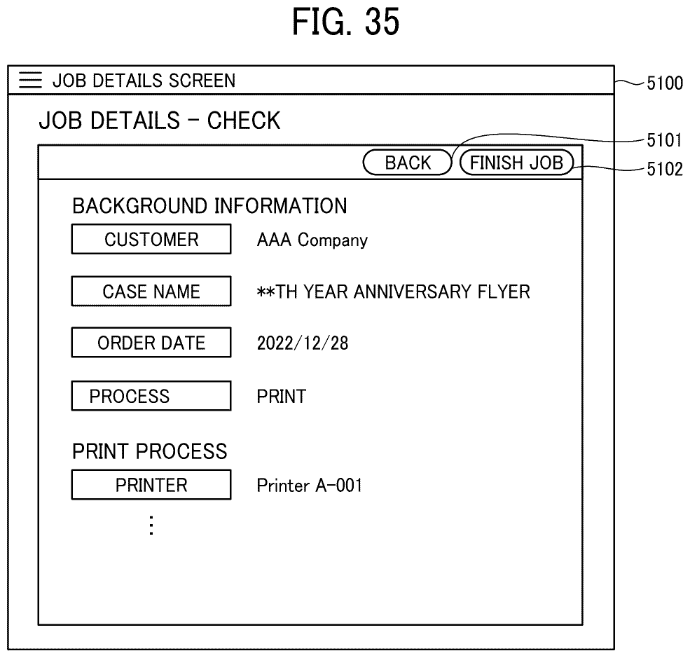

FIG. 32 is a sequence diagram illustrating example operation of processing completion of a job, performed by the information processing system 1. FIG. 33 is a diagram illustrating an example of screen transitions when job completion processing is performed by the information processing system 1. FIG. 34 is an illustration of an example job list screen when job completion processing is performed by the information processing system 1. FIG. 35 is an illustration of an example job details screen when job completion processing is performed by the information processing system 1. Referring to FIGS. 32 to 35, example operation of completing the job, performed by the information processing system 1, is described.

At S101, in response to the process supervisor operating the input unit 412, the operator terminal 41 displays the home screen 1000 illustrated in FIG. 11 on the display 815. As illustrated in FIG. 33, in response to the process supervisor pressing the “finish” button 1006 using the input unit 412, the display control 413 of the operator terminal 41 displays the job list screen 5000 illustrated in FIG. 34.

The job list screen 5000 illustrated in FIG. 34 is a screen for displaying a list of job information for which a series of processes have all been completed. As illustrated in FIG. 34, the job list screen 5000 includes a search condition input area 5001, a search button 5002, and a job list display area 5003.

The search condition input area 5001 is an area for inputting a search condition for extracting desired job information from the list of job information displayed in the job list display area 5003. The search button 5002 is a button for extracting job information that matches the search condition input in the search condition input area 5001, and displaying a list of the extracted job information in the job list display area 5003. The job list display area 5003 is an area for displaying a list of the job information for the jobs having all processes completed.

The process supervisor selects job information to be confirmed that all of the processes have been completed (may be referred to as job completion) from the job list display area 5003 using the input unit 412.

At S102, when the process supervisor selects the target job information for which the job is to be completed, from the list displayed in the job list display area 5003 using the input unit 412, the display control 413 transmits a request for acquiring the selected job information to the emission calculation system 30 via the communication unit 411.

At S103, when the communication unit 301 of the emission calculation system 30 receives the acquisition request, the communication unit 301 reads the selected job information specified by the acquisition request from the storage unit 309, and transmits the read job information to the operator terminal 41. The communication unit 411 of the operator terminal 41 receives the job information.

At S104 and S105, the display control 413 of the operator terminal 41 displays the job details screen 5100 illustrated in FIG. 35, which displays the detailed contents of the job information received at the communication unit 411.

The process supervisor confirms the contents of the job information on the job details screen 5100.

The job details screen 5100 includes a back button 5101 and a “finish job” button 5102, as illustrated in FIG. 35. The back button 5101 is a button for returning to the job list screen 5000 illustrated in FIG. 34. The “finish job” button 5102 is a button for executing the processing to complete the job.

At S106 and S107, when the process supervisor presses the “finish job” button 5102 with the input unit 412 to instruct job completion, the communication unit 411 transmits a job completion notification for notifying job completion for the selected job information to the emission calculation system 30.

The communication unit 301 of the emission calculation system 30 receives the job completion notification.

At S108, the actual emission calculator 308 of the emission calculation system 30 reads the process result information and the operating information, which correspond to the job information to be completed, from the storage unit 309. The actual emission calculator 308 calculates the actual value of activity in each process based on the process result information and the operating information, and calculates the actual value of carbon dioxide emissions based on the actual value of activity. At S109, the actual emission calculator 308 stores the calculated actual value of emissions in the storage unit 309.

At S110, the communication unit 301 of the emission calculation system 30 transmits the actual value of activity and the actual emission, which are calculated by the actual emission calculator 308, and the job completion notification, to the order management system 20. The communication unit 201 of the order management system 20 receives the actual value of activity, the actual emission, and the process completion notification. The communication unit 301 may transmit the notification indicating that the actual emission has been calculated to the operator terminal 41. In response to reception of the notification indicating that the actual emission has been calculated by the communication unit 411, the display control 413 may display a job completion screen 5200 indicating that the job has been completed, as illustrated in FIG. 33.

At S111, the registration unit 202 of the order management system 20 registers the actual emission, received by the communication unit 201, in the storage unit 206 in association with the order number of the corresponding order information.

At S112, the offset processor 205 of the order management system 20 transmits the actual emission received by the communication unit 201 to the offset intermediary system 60. The offset intermediary system 60 receives the actual emission.

At S113 and S114, the offset intermediary system 60 sends a notification to the order management system 20, which indicates the amount of credit equivalent to the received actual emission.

At S115, the actual cost calculator 204 of the order management system 20 calculates an actual amount of cost charged for the processes performed, and the amount of credit charged for such processes, based on the activity value and the actual emission that are received by the communication unit 201. The actual cost calculator 204 registers the calculated charge and credit in the storage unit 206 in association with the order number of the corresponding order information. In this case, the actual cost calculator 204 may set the amount of credit received at S114 as a billing amount for credit.

At S116, the communication unit 201 of the order management system 20 transmits, to the seller terminal 10 operated by the sales representative, an email indicating that processing of completing the job finished for the selected job information, and further indicating that calculation of the actual emission, the charge fee, and the credit have been completed.

### Checking Result

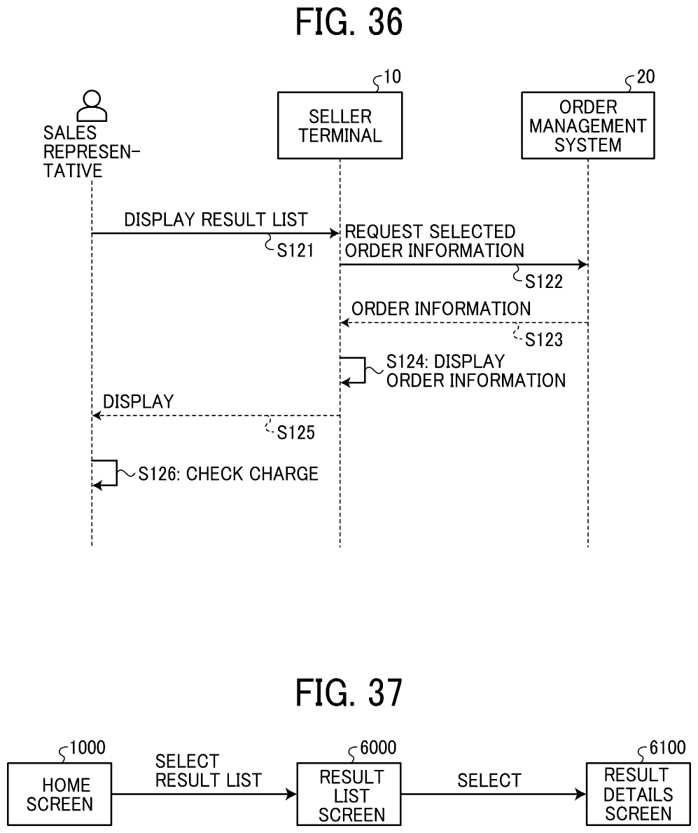

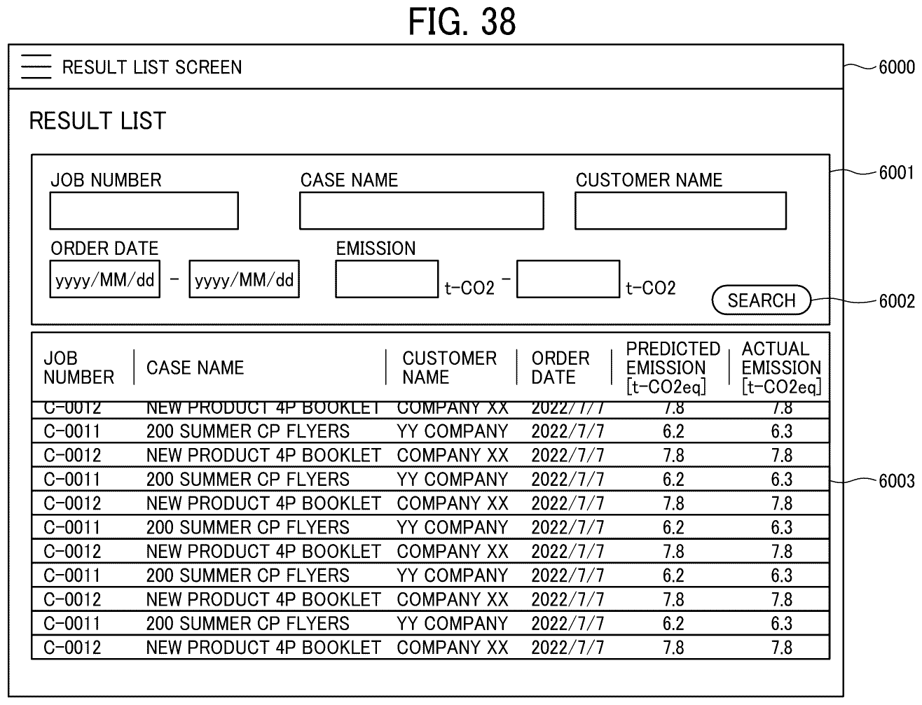

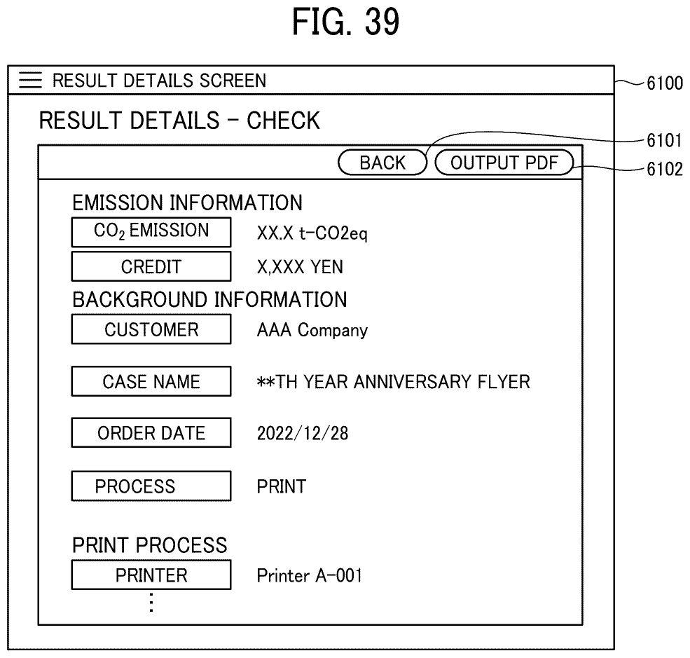

FIG. 36 is a sequence diagram illustrating example operation of checking the process result, performed by the information processing system 1. FIG. 37 is a diagram illustrating an example of screen transitions when processing of checking the result is performed by the information processing system 1. FIG. 38 is an illustration of an example result list screen when checking is performed by the information processing system 1. FIG. 39 is an illustration of an example result details screen when checking is performed by the information processing system 1. Referring to FIGS. 36 to 39, example operation of checking the result, performed by the information processing system 1, is described.

At S121, in response to the sales representative operating the input unit 102, the seller terminal 10 displays the home screen 1000 illustrated in FIG. 11 on the display 815. As illustrated in FIG. 37, in response to the sales representative pressing the “job list” button 1007 using the input unit 102, the display control 103 of the seller terminal 10 displays the result list screen 6000 illustrated in FIG. 38.

The result list screen 6000 illustrated in FIG. 38 is a screen for displaying a list of order information for which the job has been completed. As illustrated in FIG. 38, the result list screen 6000 includes a search condition input area 6001, a search button 6002, and a result list display area 6003.

The search condition input area 6001 is an area for inputting a search condition for extracting desired order information from the list of order information displayed in the result list display area 6003. For example, since the order information is associated with the actual emission calculated by the emission calculation system 30, any desired order information can be searched by specifying a range of the emissions. The search button 6002 is a button for extracting order information that matches the search condition input in the search condition input area 6001, and displaying a list of the extracted order information in the result list display area 6003. The result list display area 6003 is an area for displaying a list of the order information.

At S122, when the sales representative selects the target order information from the list displayed in the result list display area 6003 using the input unit 102, the display control 103 transmits a request for acquiring the selected order information to the order management system 20 via the communication unit 101.

At S123, when the communication unit 201 of the order management system 20 receives the acquisition request, the communication unit 201 reads, in addition to the selected order information specified by the acquisition request, the actual emission, the charge fee (the actual cost), and the amount of credit (the actual credit), each associated with the selected order information from the storage unit 206, and transmits the read information to the seller terminal 10. The communication unit 101 of the seller terminal 10 receives the selected order information, the actual emission, the actual cost and the actual credit. The actual emission, the actual cost, and the actual credit may be included in the order information.

At S124, the display control 103 of the seller terminal 10 displays a result details screen 6100 illustrated in FIG. 39, which displays the contents of the order information, the actual emission, the actual cost, and the actual credit, which are received by the communication unit 101. The sales representative confirms the contents of the order information, the actual emission, the actual cost, and the actual credit on the result details screen 6100.

The result details screen 6100 is a screen for displaying the contents of the order information, the actual emission, the actual cost, and the actual credit. In the example illustrated in FIG. 39, the amount of credit (“credit”) is displayed. In addition to the credit, the charge fee may be displayed, which is the actual cost. As illustrated in FIG. 39, the result details screen 6100 includes a back button 6101 and an “output PDF” button 6102. The back button 6101 is a button for returning to the result list screen 6000. The “output PDF” button 6102 is a button for outputting the contents displayed on the result details screen 6100 in the form of a PDF file.

As described above, in the information processing system 1, the communication unit 201 of the order management system 20 acquires (receives), from the seller terminal 10, order information including processing conditions (printing conditions) of one or more processes for producing a product such as a printed matter. The registration unit 302 of the emission calculation system 30 registers the order information as job information. The job information transmitter 305 of the emission calculation system 30 transmits the job information registered by the registration unit 302 to a management apparatus (for example, the print management system 40) that manages execution of the process. The communication unit 301 of the emission calculation system 30 acquires (receives) result information indicating an operating status of the process, such as operating information or process result information. The actual emission calculator 308 calculates an actual value of carbon dioxide emissions based on the result information acquired (received) by the communication unit 301. The predicted emission calculator 303 calculates a prediction value of carbon dioxide emissions from new job information registered by the registration unit 302, based on the actual value of carbon dioxide emissions calculated by the actual emission calculator 308. With the above-described configuration, the predicted value of carbon dioxide emissions can be accurately calculated.

Further, in the information processing system 1, the predicted value of carbon dioxide emissions in producing the product can be calculated timely.

More specifically, the predicted value of carbon dioxide emissions can be obtained with high accuracy, at the time of receiving an order of the product.

In the information processing system 1, the communication unit 201 of the order management system 20 transmits the predicted value of emissions, which is calculated by the predicted emission calculator 303, to the seller terminal 10 to display the predicted emission at the seller terminal 10. With this configuration, the prediction value of carbon dioxide emissions, which is generated in the processes to produce the product according to the order, is displayed to the customer. Further, the estimate including the estimated amount of credit may also be displayed.

In the information processing system 1, the predicted emission calculator 303 calculates the prediction value of carbon dioxide emissions, using the predicted value of activity. To obtain the value of activity, the job information registered by the registration unit 302 is input to the learning model, which outputs the value of activity. The leaning model is generated by learning with teacher data in which the actual value of activity in a specific process is labeled to the job information. With the above-described configuration, the predicted value of carbon dioxide emissions is calculated using the output (activity) of the learning model, which is generated by learning the actual value of the past activity. Accordingly, the predicted value of carbon dioxide emissions can be accurately obtained.

In this disclosure, when any one of the functional units of the information processing system 1 is implemented by a program executed by the CPU, such program may be installed in a ROM or any desired memory of the information processing system 1 in advance.

Alternatively, the computer program executed in the information processing system 1 can be provided as a file in an installable format or an executable format and stored in a computer-readable recording medium, such as a compact disc read only memory (CD-ROM), a flexible disk (FD), a compact disc recordable (CD-R), and a digital versatile disk (DVD). Further, the program executed by the information processing system 1 may be stored on a computer connected to a network such as the Internet, to be downloaded via the network. Further, the computer program executed in the information processing system 1 may be provided or distributed via a network such as the Internet. The program executed by the information processing system 1 has a module configuration including at least one of the above-described functional units. As a CPU reads the program from the above-described memory and executes the program, each of the above-described functional units is loaded onto the main memory (work area) to operate as the functional unit.

Examples of the product include printed matter, such as booklets, advertisements, posters, leaflets, pamphlets, promotional materials, distribution materials, slips, materials, and commercial printed matter. Other examples of the product include clothing (apparel), construction materials, food, equipment, devices, vehicles, materials, parts or components, semiconductors, and recycled products. In other words, the above-described system is applicable to various products produced in various manufacturing industries. For example, in the case of clothing, the processes include production of raw materials or materials, spinning, dyeing, cutting, sewing, and delivery. The processing conditions of such processes include, for example, the type of materials (fabric, thread, parts or components), the processing method of the materials, the type of dye, the dyeing method, and the size. The job is executed based on first job information using order information including the processing conditions of these processes. The actual value of carbon dioxide emissions is calculated based on the result information indicating the result of executing the processes. Further, the predicted value of carbon dioxide emissions for the second job is calculated based on the actual value of carbon dioxide emissions. The predicted value may be output as the presentation materials or reports in the form of print out or an electronic file, for example, when the production company receives an order for the product from the brand company. For example, such materials or reports include, for each processing condition, the estimated price of the product, the predicted value of carbon dioxide emissions, and the estimated credit.

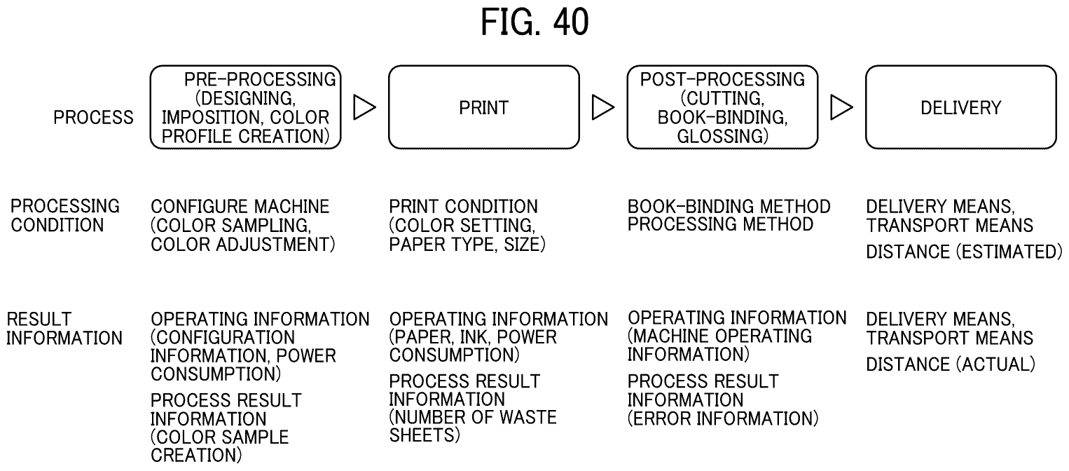

FIG. 40 is a diagram illustrating example processing conditions of the processes for producing the printed matter. The processing conditions in the pre-processing process include device (printer) configuration, and color sample matching or color adjustment as a preparatory process. The result information in the pre-processing process includes, for example, configuration information and power consumption as the operating information, and color sample creation information as the process result information. The processing conditions in the printing process including printing conditions, such as color setting, paper type, and paper size. The result information in the printing process includes, for example, paper, ink, and power consumption as the operating information, and the number of waste sheets as the process result information. The processing conditions in the post-processing process include, for example, a bookbinding method and a processing method. The result information in the post-processing process includes, for example, machine operating information as the operating information, and error information of machines or operations as the process result information. The processing conditions in the delivery process include, for example, planned delivery means and an estimated transportation distance. The result information in the delivery process includes, for example, actual delivery means and an actual transportation distance. The transportation distance may be obtained, for example, from a meter of a vehicle.

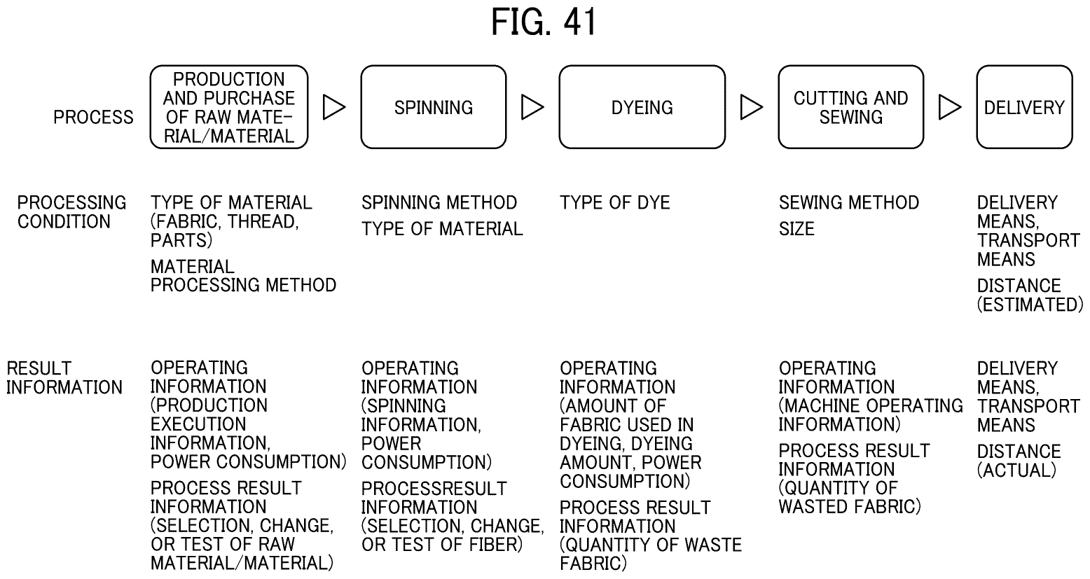

FIG. 41 is a diagram illustrating example processing conditions of the processes for producing the clothing. In the process of production and purchase of raw materials or materials, the processing conditions include the types of selected materials (fabric, thread, parts or components) and the method of processing the materials. The result information in such process includes, for example, production execution information and power consumption as the operating information, and information on selection, change, or test of raw materials or materials as the process result information. In the spinning process, the processing conditions include, for example, the spinning method and the types of the materials. The result information in the spinning process includes, for example, spinning execution information and power consumption as the operating information, and information on selection, change, or test of fibers as the process result information. In the dyeing process, the processing conditions include, for example, the type of dye. The result information in the dyeing process includes, for example, information on the amount of fabric used in the dyeing machine, the amount of dye, and power consumption of the dyeing machine, as the operating information, and information on the quantity of waste fabrics as the process result information. In the cutting and sewing process, the processing conditions include, for example, the sewing method and a size. The result information includes, for example, machine operation information as the operating information, and information on the quantity of waste materials as the process result information. In the delivery process, the processing conditions are the same as those described above referring to FIG. 40. In the case of the clothing, the operating information that the second terminal acquires from the management apparatus for the dyeing process may be at least one of the information on the amount of fabric used in the dyeing machine, the amount of dye, and the power consumption of the dyeing machine. The process result information, which is input to the second terminal, may be the quantity of waste fabrics, for example.

Aspects of the present invention are as follows.

According to a first aspect, the emission calculation system includes a first acquisition unit, a registration unit, a first transmission unit, a second acquisition unit, a first calculation unit, and a second calculation unit. The first acquisition unit acquires, from the first terminal, order information including processing conditions of one or more processes for producing a product. The registration unit registers first job information based on the order information acquired by the first acquisition unit. The first transmission unit transmits the first job information registered by the registration unit to the management apparatus that manages execution of the processes. The second acquisition unit acquires result information indicating a result of executing the processes from the management apparatus. The first calculation unit calculates an actual value of carbon dioxide emissions for a job based on the first job information, using the result information acquired by the second acquisition unit. The second calculation unit calculates a predicted value of carbon dioxide emissions for a job based on the second job information registered by the registration unit, using the actual value of carbon dioxide emissions calculated by the first calculation unit.

According to the second aspect, the emission calculation system of the first aspect further includes a second transmission unit that transmits the predicted value of carbon dioxide emissions calculated by the second calculation unit to the first terminal for display at the first terminal.

According to the third aspect, in the emission calculation system of the first aspect or the second aspect, the second acquisition unit acquires operating information from the management apparatus as the result information.

According to the fourth aspect, in the emission calculation system of the third aspect, when the one or more processes include a printing process, the operating information includes at least one of information on a number of sheets of paper, an amount of toner or ink, and power consumption of a printer.

According to the fifth aspect, in the emission calculation system of any one of the first to fourth aspects, the second acquisition unit acquires, as the result information, process result information of the process input to a second terminal by a user operation.

According to the sixth aspect, in the emission calculation system of the fifth aspect, the process result information includes the number of waste sheets.

According to the second aspect, the emission calculation system further includes a third calculation unit that calculates an estimated cost incurred by the execution of the one or more processes based on the order information. The second transmission unit transmits the estimated cost calculated by the third calculation unit to the first terminal with the predicted value corresponding to the estimated cost, so that the estimated cost and the predicted value are displayed at the first terminal.

According to the eighth aspect, in the emission calculation system of the seventh aspect, the third calculation unit further calculates an estimated credit for offsetting the predicted value of carbon dioxide emissions, calculated by the second calculation unit, based on the order information acquired by the first acquisition unit. The second transmission unit transmits the estimated credit calculated by the third calculation unit to the first terminal with the predicted value, such that the estimated credit corresponding to the predicted value is displayed on the first terminal.

According to the ninth aspect, in the emission calculation system of any one of the first aspect to the eighth aspect, the second calculation unit calculates the predicted value of carbon dioxide emissions using a predicted value of activity, which is obtained as an output of a learning model, when the second job information registered by the registration unit is input to the learning model. The learning model is generated by learning teacher data in which the first job information is labeled with the actual value of activity in the execution of the one or more processes.

According to the tenth aspect, in the emission calculation system of the ninth aspect, the second calculation unit adjusts a hyperparameter used for the learning by the learning model according to a difference between the actual value and the predicted value of carbon dioxide emissions, and causes the learning model to learn the teacher data again.

According to the eleventh aspect, the emission calculation system according to any one of the first to tenth aspects further includes a notification unit that sends a notification to an information terminal of a process operator of the a process subsequent to the process having been completed, after the result information is acquired by the second acquisition unit in response to completion of the processes.

According to the twelfth aspect, in the emission calculation system of the ninth aspect, the registration unit updates the second job information in response to an operation input to a second terminal. The second calculation unit calculates the predicted value of carbon dioxide emissions again by inputting the second job information updated by the registration unit to the learning model.

According to the thirteenth aspect, in the emission calculation system of the seventh aspect, the second calculation unit calculates the predicted value of carbon dioxide emissions for each processing condition included in the second job information. The third calculation unit calculates the predicted value for each processing condition included in the order information.

According to the fourteenth aspect, in the emission calculation system of the first aspect, the second job information is new job information registered after registration of the first job information, the first job information being the past job information for which the processes are completed. The second calculation unit calculates, when the new job information is registered, a predicted value of carbon dioxide emissions for the job based on the new job information, based on the actual value for the job based on the past job information.

According to the fifteenth aspect, the product is clothing. The second acquisition unit acquires, as the result information, operating information from the management apparatus, and process result information regarding the processes input to the second terminal by the user operation. In the case of the dyeing process, the operating information includes at least one of information on an amount of fabric used in a dyeing machine, an amount of dye, and power consumption of the dyeing machine. The process result information is the quantity of waste fabric.

According to the sixteenth aspect, an emission calculation method includes: acquiring, from a first terminal, order information including processing conditions of one or more processes for producing a product; registering first job information based on the order information; transmitting the first job information to a management apparatus that manages execution of the one or more processes; acquiring result information indicating a result of executing the one or more processes from the management apparatus; calculating, based on the result information, an actual value of carbon dioxide emissions for a first job indicated by the first job information; and calculating a predicted value of carbon dioxide emissions for a second job indicated by the second job information that is newly registered, based on the actual value of carbon dioxide emissions.

According to the seventeenth aspect, a program causes a computer to perform the above-described emission calculation method.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A system for calculating emission, comprising
circuitry configured to:
acquire, from a first terminal, order information including processing conditions of one or more processes for producing a product;
register in a memory first job information based on the order information;
transmit the first job information to one or more management apparatuses that manage execution of the one or more processes;
acquire result information indicating a result of executing the one or more processes;
calculate, based on the result information, an actual value of carbon dioxide emissions for a first job corresponding to the first job information; and
in a case that second job information is registered, calculate a predicted value of carbon dioxide emissions for a second job corresponding to the second job information, based on the actual value of carbon dioxide emissions for the first job.

2. The system of claim 1, wherein the circuitry is further configured to transmit the predicted value of carbon dioxide emissions to the first terminal for display at the first terminal.

3. The system of claim 1, wherein the circuitry is configured to
acquire, as the result information, operating information of one or more apparatuses that executed the one or more processes from the one or more management apparatuses.

4. The system of claim 3, wherein
in a case that the one or more processes include a printing process, and the one or more apparatuses include a printer executed the printing process,
the operating information includes at least one of information on a number of sheets of paper, an amount of toner or ink, or power consumption of the printer.

5. The system of claim 1, wherein the circuitry is configured to
acquire, as the result information, process result information indicating the result of executing the one or more processes having been input to a second terminal by a user operation, from the second terminal.

6. The system of claim 5, wherein
in a case that the one or more processes include a printing process,
the process result information includes a number of waste sheets.

7. The system of claim 2, wherein the circuitry is further configured to
calculate an estimated cost incurred by the execution of the one or more processes based on the order information; and
transmit the estimated cost to the first terminal in addition to the predicted value of carbon dioxide emissions, such that the estimated cost is displayed in association with the predicted value of carbon dioxide emissions at the first terminal.

8. The system of claim 7, wherein the circuitry is further configured to
calculate an estimated credit for offsetting the predicted value of carbon dioxide emissions based on the order information, and
transmit the estimated credit to the first terminal, such that the estimated credit is displayed in association with the predicted value of carbon dioxide emissions at the first terminal.

9. The system of claim 1, wherein the circuitry is configured to
calculate the predicted value of carbon dioxide emissions using a predicted value of activity obtained as an output of a learning model to which the second job information is input,
the learning model being generated by learning teacher data in which the first job information is labeled with the actual value of activity in the execution of the one or more processes.

10. The system of claim 9, wherein the circuitry is configured to
adjust a hyperparameter used for the learning by the learning model, based on a difference between the actual value of carbon dioxide emissions and the predicted value of carbon dioxide emissions, and
cause the learning model to learn the teacher data again using the adjusted hyperparameter.

11. The system of claim 1, wherein
the one or more processes include a preceding process and a subsequent process,
the circuitry is configured to transmit a notification to a second terminal operated by a process operator in charge of the subsequent process, after the result information is acquired in response to completion of the preceding process.

12. The system of claim 9, wherein the circuitry is further configured to
update the second job information in response to a user operation on a second terminal; and
calculate the predicted value of carbon dioxide emissions again by inputting the updated second job information to the learning model.

13. The system of claim 7, wherein the circuitry is further configured to
calculate the predicted value of carbon dioxide emissions for each processing condition included in the second job information, and
calculate the predicted value for each processing condition included in the order information.

14. The system of claim 1, wherein
the first job information is information on a past job having the one or more processes completed, and
the second job information is new job information registered after the registration of the first job information.

15. The system of claim 1, wherein
the result information includes operating information received from the one or more management apparatuses and process result information input to a second terminal,
in a case that the product is clothing, and the one or more processes include a dyeing process,
the operation information includes at least one of information on an amount of fabric used in a dyeing machine, an amount of dye, and power consumption of the dyeing machine, and
the process result information includes a quantity of waste fabric.

16. An information processing system, comprising:
the system of claim 1; and
the first terminal comprising a display configured to display the predicted value of carbon dioxide emissions corresponding to the order information.

17. A method of calculating emission, comprising:
acquiring, from a first terminal, order information including processing conditions of one or more processes for producing a product;
registering in a memory first job information based on the order information;
transmitting the first job information to one or more management apparatuses that manage execution of the one or more processes;
acquiring result information indicating a result of executing the one or more processes;
calculating, based on the result information, an actual value of carbon dioxide emissions for a first job corresponding to the first job information; and
calculating a predicted value of carbon dioxide emissions for a second job corresponding to second job information that is registered after the registration of the first job information, based on the actual value of carbon dioxide emissions for the first job.

18. The method of claim 17, further comprising:
displaying the predicted value of carbon dioxide emissions corresponding to the order information.

19. A non-transitory recording medium storing a plurality of instructions which, when executed by one or more processors, causes the processors to perform a method comprising:
acquiring, from a first terminal, order information including processing conditions of one or more processes for producing a product;
registering in a memory first job information based on the order information;
transmitting the first job information to one or more management apparatuses that manage execution of the one or more processes;
acquiring result information indicating a result of executing the one or more processes;
calculating, based on the result information, an actual value of carbon dioxide emissions for a first job corresponding to the first job information; and
calculating a predicted value of carbon dioxide emissions for a second job corresponding to second job information that is registered after the registration of the first job information, based on the actual value of carbon dioxide emissions for the first job.
